(19) United States
(12) Patent Application Publication
(10) Pub. No.: US 2010/0032371 A1
(43) Pub. Date: Feb. 11, 2010

(54) Method and system for controlling biodegradation and temperature in an aerobic or anaerobic subsurface or partially enclosed waste mass

(75) Inventors: Harold W. Bentley, Tucson, AZ (US); Richard W. Bentley, Tuscon, AZ (US)

Correspondence Address: LAWRENCE R. OREMLAND, P.C., 5055 E. BROADWAY BLVD., SUITE C-214, TUCSON, AZ, 85711, US

(73) Assignee: Hydro Geo Chem, Inc., Tuscon, AZ (US)

(21) Appl. No.: 12/416,875

(22) Filed: Apr. 1, 2009

Related U.S. Application Data
(60) Provisional application No. 61/041,859, filed on Apr. 2, 2008.

(51) Int. Cl. C02F 3/00

(52) U.S. Cl. 210/604; 210/612

(57) ABSTRACT

This invention is a new and useful method for controlling the temperature and biodegradation rate of an anaerobic or aerobic landfill or other enclosed or partially enclosed waste mass. The heat generated by a waste mass is carried away by air and moisture within the air resulting from evaporation of liquid within the waste mass as air passes through the waste mass. With the invention, the resulting exhaust gases are passed through a system acting as a heat exchanger and an exhaust gas director. During this process, the exhaust gases may be optionally vented to the atmosphere or to a processing system prior to passing through the portion of the system that acts as a heat exchanger; the exhaust gases may be vented to the atmosphere or to a processing system after passing through the heat exchanging portion; the exhaust gases may be recycled through the waste mass with no additional air or other gas introduced; or the exhaust gases may be amended by addition of air or other gases and then recycled through the waste mass. The process thus allows temperature control without changing the rate of biodegradation within the waste mass by circulating air that cools by carrying away vaporized liquids within the waste mass when such conditions are required. The process also allows temperature control simultaneously with biodegradation control by changing or removing entirely the oxygen content of the recirculated air. The device thus also alters the biodegradation rate and thereby allows raising, lowering, or maintaining the existing temperature within the waste mass. The major benefits of the invention are much more effective control of waste mass temperature and biodegradation, and substantially less power requirements and equipment costs to accomplish these benefits.

### RELATED APPLICATION/CLAIM OF PRIORITY

This application is related to and claims priority from the U.S. Provisional Application Ser. No. 61/041,859, filed Apr. 2, 2008, which provisional application is incorporated by reference herein.

### BACKGROUND OF THE INVENTION

Aerobic biodegradation of solid waste provides an attractive option for landfill management, as the process can result in more rapid settling to create additional space for solid waste disposal. Aerobic biodegradation can be used to reduce methane emissions for landfills, particularly those that are not generating enough methane to warrant gas collection systems. The heat released by the aerobic biodegradation process can be used to treat leachate recirculated into the landfill by evaporating its water and biodegrading its organic compounds. Aerobic biodegradation can also be used for substantial in situ reduction or elimination of toxic volatile organic compound emissions from the landfill.

Aerobic biodegradation in a landfill is carried out by microorganisms that are dependent on oxygen to metabolize the organic substances in landfill solid waste. The end products are normally carbon dioxide and water. Some organic substances are very resistant to degradation (e.g. certain plastics); however, a substantial percentage of municipal solid waste (MSW) can be degraded to the normal end products. Because oxygen is a very reactive compound, the microorganisms that utilize it in their enzyme systems to metabolize solid waste, termed aerobic microorganisms, do so at rates that are one or more orders of magnitude more rapid than those microorganisms, termed anaerobic, that function without the presence of oxygen. Living organisms utilize substances for growth or energy in steps that are energetically favorable for the organisms. The overall process releases energy in the form of heat that can result in increasing the temperature of the substrate, in this case MSW, in which the microorganisms exist.

Aerobic biodegradation not only proceeds at a much faster rate than anaerobic biodegradation but also releases substantially more heat per mass of organic material consumed. Since a landfill is a high volume, low thermal conductivity structure, the heat released by biodegradation cannot be easily dissipated to the surrounding environment to cool the waste mass. The resulting increase in temperature creates a problem for both the biodegrading microorganisms and the landfill operator, since high temperature has been shown to inhibit or kill the microorganisms and create underground fires by spontaneous combustion. The critical temperature at which spontaneous combustion has been observed to start is generally 70 to 80° C., above which point one is likely to see a dramatic and possibly uncontrollable temperature rise, even to the point of combustion. Therefore, steps must be taken by the aerobic landfill operator to cool the landfill to below the critical temperature.

A second consideration is the variability of biodegradation rate with temperature. The landfill operator must target the proper temperature for maximum rate of degradation in order to be as efficient as possible during aerobic landfill operation. Studies have shown that the optimum temperature for biodegradation varies with the type of waste that is being aerated. For fresh MSW, that optimum temperature has been shown to be 60° C. In this case, there is a minimum of a ten degree window before the critical temperature is reached for uncontrolled temperature rise and the resulting damage. The landfill operator is then faced with the delicate balancing act of maintaining the waste temperature high enough to optimize the biodegradation rate, yet low enough to prevent runaway temperature rises.

MSW is typically very heterogeneous. Not only does its content vary in terms of types of biodegradable and nondegradable material, but the density, permeability, moisture content, and hydraulic conductivity of the waste mass also vary. All of these parameters contribute to a variable thermal conductivity and rate of heat generation throughout the landfill waste, resulting in variable effectiveness of cooling methods to maintain temperatures below the critical temperature. The existence of “hot spots”, locations that might reach this critical temperature, should be taken into account in any cooling system design.

Temperature in an aerobic landfill is normally controlled by forced injection and/or extraction of air through the waste mass while supplying water (and/or landfill leachate) to replace the water evaporated. The flow of air supplies oxygen for biodegradation reactions and carries away excess heat stored as latent heat in water vapor. The airflow demand for cooling exceeds that required to supply oxygen for biodegradation by an order of magnitude or more. The water evaporated can be replaced efficiently by water (and/or leachate) recharged into the landfill by pressurized drip irrigation, sprinklers, or other methods known to practitioners of the art. The optimum moisture level for biodegradation ranges from 40% to 60% moisture by weight. However, the practical application of aerobic bioreactors is limited to wastes with significantly lower moisture contents.

Three issues must be considered with regard to moisture content in a landfill. Firstly, increasing MSW moisture level to 40% to 60% increases water permeability significantly in accordance with the general principles of flow in porous media. The higher water permeability results in water management problems associated with seeps from the sides of the landfill and increasing landfill drainage to underlying soils or landfill liner. Our experience indicates that the actual percentage by weight of moisture that can be easily maintained in landfills (commonly termed “field moisture capacity”) is approximately 20 to 30%. Higher moisture contents, 40% or above, are typically found only when excessive water injection is practiced or where water is “perched” on underlying, low-water-permeability layers of residual, fine-grained sediments used for daily cover. Secondly, a moisture content as high as 40% to 60% in solid waste will fill in waste material pores, thereby reducing air permeability to levels that limit or prevent effective air flow to the waste. The reduction in the rate of air delivery caused by the significant reductions in gas permeability associated with high moisture content results in a substantial reduction in the rate of cooling. Even with enough moisture present to continually saturate the air as it passes through the waste mass, the cooling requirements will not be met if the air supply to the MSW is insufficient to carry the water vapor needed to transport the excess heat. The rate of airflow is the critical factor regarding whether the waste mass is effectively cooled. Thirdly, this reduction in air delivery to portions of the waste may reduce oxygen supply below levels required to sustain significant rates of aerobic biodegradation, even though some flow may occur via channeling through the large pores that are typical in solid waste. In summary, from a practical point of view, it is not possible to utilize the higher 40 to 60% levels of moisture that provide maximum biodegradation rates.

The goal of the invention is to optimize the aerobic biodegradation rate under the conditions existing in and around the waste mass. The moisture content of the waste must be properly maintained, and the other, landfill-specific variables familiar to those in the art must be considered in the operational design in order to keep the temperature of the waste mass within controllable limits and within the range of effective biodegradation. Controlling the temperature of the waste mass requires supplying the correct flow of air through the waste mass. Air flow must be maintained at a high enough rate to keep the waste below a temperature that may kill or unduly inhibit the microorganisms or initiate spontaneous combustion, but also must be at a low enough rate that the waste is not cooled to the point of slowing the biodegradation rate. It is important to recognize that airflow and water supply will vary significantly over the aerobic bioreactor's operational period.

In the case of an anaerobic waste mass, the goal of the invention is to reduce the internal temperature of the waste mass to levels that are not inhibitory to methanogenesis (biological generation of methane). Heat removal in anaerobic waste cannot be accomplished with airflow containing enough oxygen to be toxic to the methanogenic microbes. Oxygen would furthermore initiate aerobic biodegradation, which would accelerate heat generation. Heat generation can be controlled in such a waste mass by collecting the waste's landfill gas (which is depleted in oxygen), cooling it (reducing its water and heat content), and recirculating it through the waste mass to carry away the waste's excess heat. The cooling mechanism would be the same as that used for an aerobic waste mass; i.e., evaporation of water within the waste mass as the gas passes through, the heat being carried away by virtue of the latent heat of vaporization of water. The anaerobic waste mass would be the source of the recirculating landfill gas, which would be composed of approximately 50% methane and 50% carbon dioxide.

Airflow through a porous medium such as a waste mass is a complex physical process. However, such flow can be approximated by Darcy's Law, expressed here in the following form:

$${F}_{v} = \frac{κ A}{L μ} Δ P \qquad ( 1 )$$

where Fᵥ is the volumetric rate of flow (m³-sec⁻¹), κ is the gas permeability (m²), A is the cross sectional area (m²) of the waste mass volume, L is the length (m) of the waste mass through which the air flows, μ is the dynamic viscosity (kg-m⁻¹s⁻¹) of the air, and ΔP is the pressure gradient (Newton-m⁻²) required for the given airflow. An approximated physical depiction would be a (straight) line of a plurality of equally-spaced injection wells manifolded into an air-injection blower which moves air through the waste mass towards another straight line of a plurality of equally-spaced extraction wells configured in a similar manner as the injection well system (extraction blower and manifolded wells).

We illustrate the analysis of an aerobic bioreactor landfill by choosing a conceptual landfill that we will call Example Landfill. Airflow through the Example Landfill's waste mass can be depicted for purposes of simplicity as unidirectional from one line of wells to another through a rectangular cross-sectional area. Assumed dimensions are 180 meters in length for each line of wells, a length of 30 meters between adjacent lines of wells, and an effective landfill depth of 10 meters. The distance between the wells in a line of wells is indeterminate; the wells are assumed to be evenly spaced and close enough to each other to provide substantially parallel flow lines that are perpendicular to the well lines. Given any set of values for the variables κ, L, A, and μ, we can express ΔP as proportional to Fᵥ, with the other variables in the equation forming the proportionality constant at that temperature.

In our approximation of the Example Landfill, we recognize that as air passes through the landfill, the pressure variation in the airflow affects the values of the dynamic viscosity μ at a given temperature. The permeability κ of the landfill waste can furthermore change over time due to factors such as settling and grain size changes during conversion of the solid waste to carbon dioxide and water. We approximate the dynamic viscosity value as that at an average pressure of 1-atmosphere. Although permeability is universally acknowledged to change over time in a biodegrading landfill, there is no consensus regarding an empirical function for showing these changes and, in fact, the solid waste community differs on whether the permeability may either increase or decrease depending on site-specific conditions. We therefore assume a reasonable value for the permeability and hold it constant as we model the effect of flow increases on pressure. We also assume a constant value for the porosity. However, that parameter does not enter into the current discussion, but will be used later in the section on biodegradation of the landfill waste.

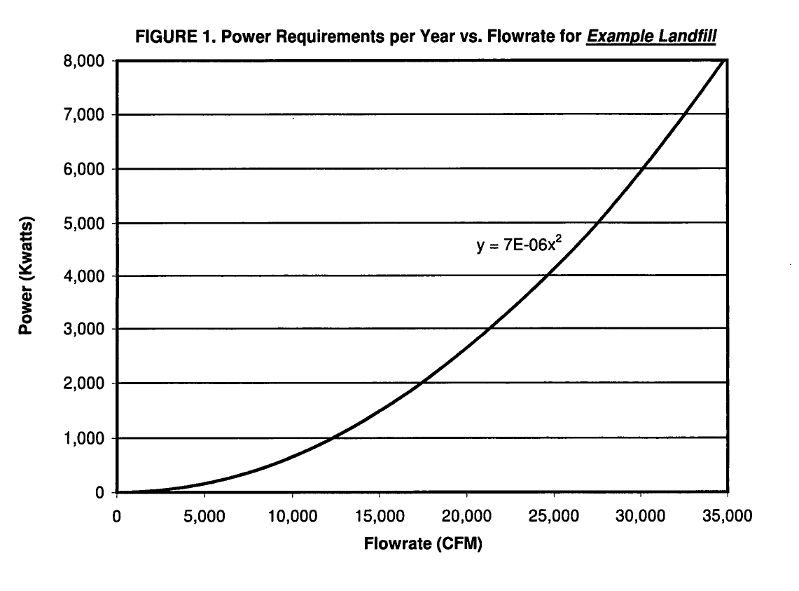

For the conceptual Example Landfill, we assume the following reasonable parameter values: κ=1.00×10⁻¹¹ m² (in our experience, a representative average horizontal permeability for landfill waste); μ=1.82×10⁻⁵ kg-m⁻¹s⁻¹ (viscosity of water-saturated air at 60° C., the optimum temperature for biodegradation of typical solid waste); L=30 m, and A=180 m×10 m, or 1800 m². Then Fᵥ=3.30×10⁻⁵ ΔP, which allows us to calculate ΔP at a given flow rate. We note that the product, Fᵥ ΔP, has units of Newton-m/sec, or power (work per unit time) in watts. Therefore, the power requirements are easily calculated for a given flow rate through a waste mass with a known permeability, gas viscosity, flowpath length, and cross-sectional area. FIG. 1 presents a graph of the power requirements using equation (1) and the above values for various flow rates. Table 1 provides the numerical values that make up the graph.

Note that FIG. 1 shows a quadratic rise in power requirements with a linear increase in the air flow. The utility of the invention is that it can control the waste mass temperature at a lower air flow rate, thus consuming much less power. The invention accomplishes the more energy-efficient cooling by periodically extracting oxygen-depleted air from the waste mass, recycling this air through a heat exchanging unit to remove much of its heat and waste vapor, then back through the waste mass. In so doing, the device allows cooling of the waste mass by halting or substantially reducing the heat generated by biodegradation within the waste mass while still allowing heat to be removed from the waste by vaporization of the liquid water associated with the waste mass. Much of this evaporated water will be condensed by the heat exchanger and would be available for reinjection into the waste mass to help maintain the moisture content of the aerobic bioreactor. The intent of this section is to discuss the power requirements versus flow for a model landfill and show why the invention has value. As will be discussed in the detailed description of the invention, as the waste mass in any aerobic landfill is biologically degraded the flow rate needed to maintain the landfill at a given temperature will drop over time.

### BRIEF SUMMARY OF THE INVENTION

The invention operates in a repetitive sequence of cooling (recycle, atmosphere off) mode and aerobic (atmosphere on) mode. In the cooling mode, the operational apparatus consists of: 1) one or more gas extraction blowers that extract the exhaust gases from a manifold of one or more extraction wells and/or trenches installed in the waste landfill; 2) a heat exchanging unit that receives and cools the extracted exhaust gases and condenses out their excess water (which may be used to resupply the landfill waste); and 3) one or more gas injection blowers that receive the exhaust gases, depleted of oxygen and reduced in temperature and excess moisture, and reinjects them into a manifold of one or more injection wells and/or trenches installed in the waste, and then back through the waste mass to assist in cooling. In the aerobic mode, the exhaust gases are extracted directly from the extraction manifold and injected into the atmosphere, before or after being processed by the heat exchanger, and the injection blower is used to inject air from the atmosphere into the manifold, then into the waste in order to sustain aerobic biodegradation. In a second configuration, extraction and injection could be accomplished by using one or more blowers operating in both extraction and injection modes while switching valves (manually or automatically, to meet the bioreactor's recycling and aerobic mode requirements. In this second configuration, passive extraction (venting) would be employed to exhaust gases during the aerobic mode. The invention can be used to regulate the temperature of the waste mass between a lower and higher temperature set point to control the biodegradation rate, which may be in either an anaerobic or aerobic state. In the case of an aerobic waste mass, the required air flow rate for temperature control is reduced, resulting in substantially lower energy costs. In the case of anaerobic waste mass, oxygen depleted air is recycled through the waste mass to provide enough cooling to maintain high anaerobic waste decay rates.

### BRIEF DESCRIPTION OF DIAGRAMS AND TABLES

FIG. 1 is a graph of airflow rate versus power requirement to aerobically degrade the Example Landfill.

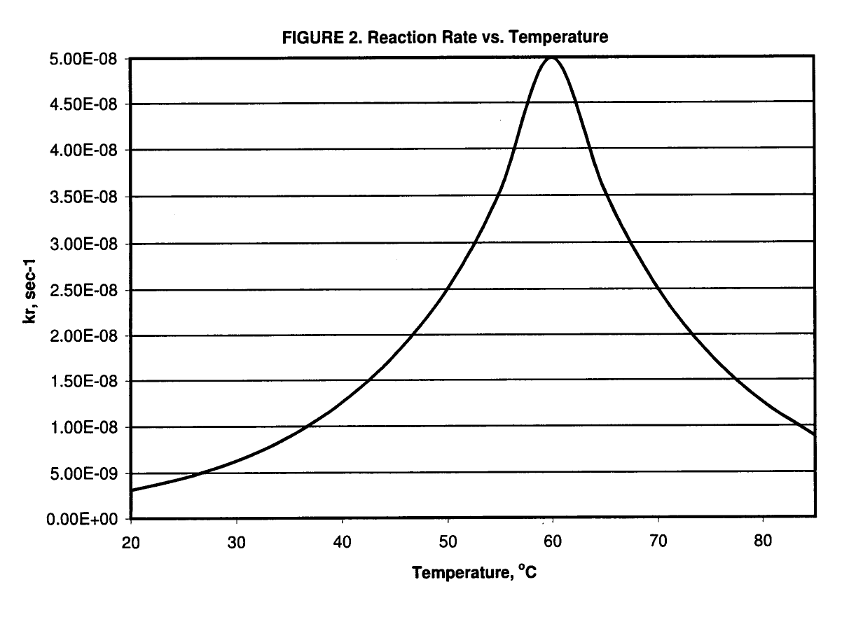

FIG. 2 is a graph of the calculated biodegradation rates over the temperature range of 20 to 85° C. using the Arrhenius equation and one selected maximum rate at 60° C.

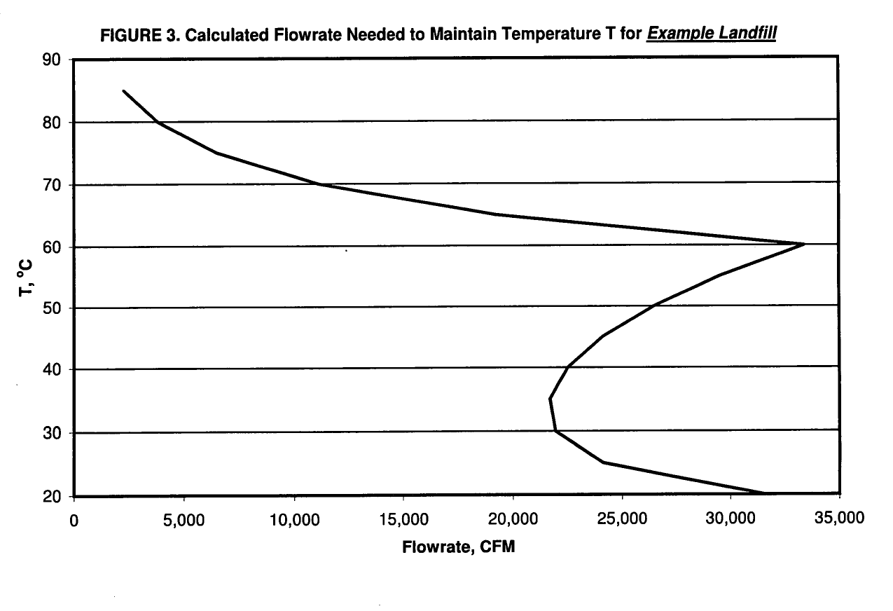

FIG. 3 is a graph of air flow rates required to maintain the Example Landfill at a given temperature assuming a biodegradable fraction of 0.05.

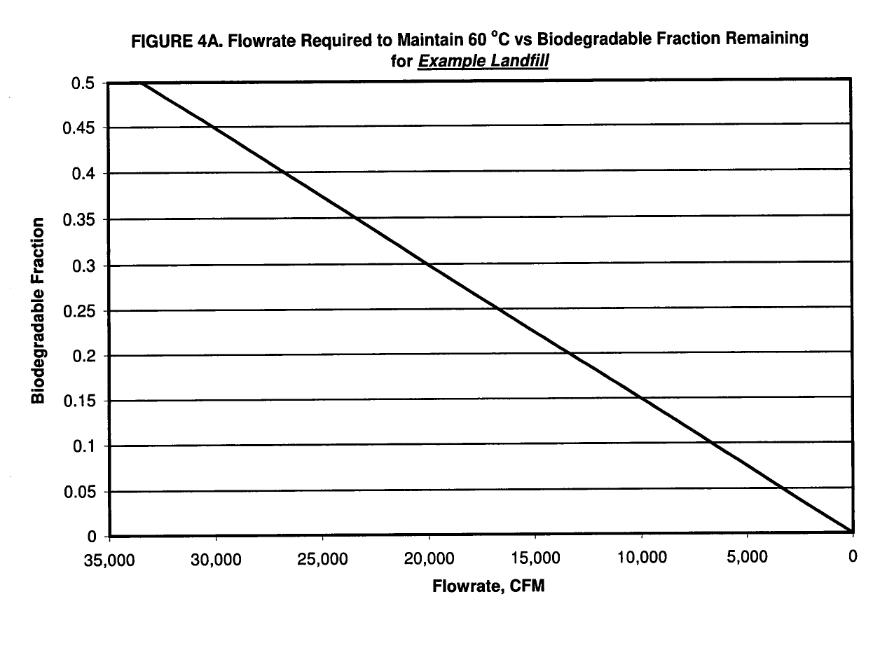

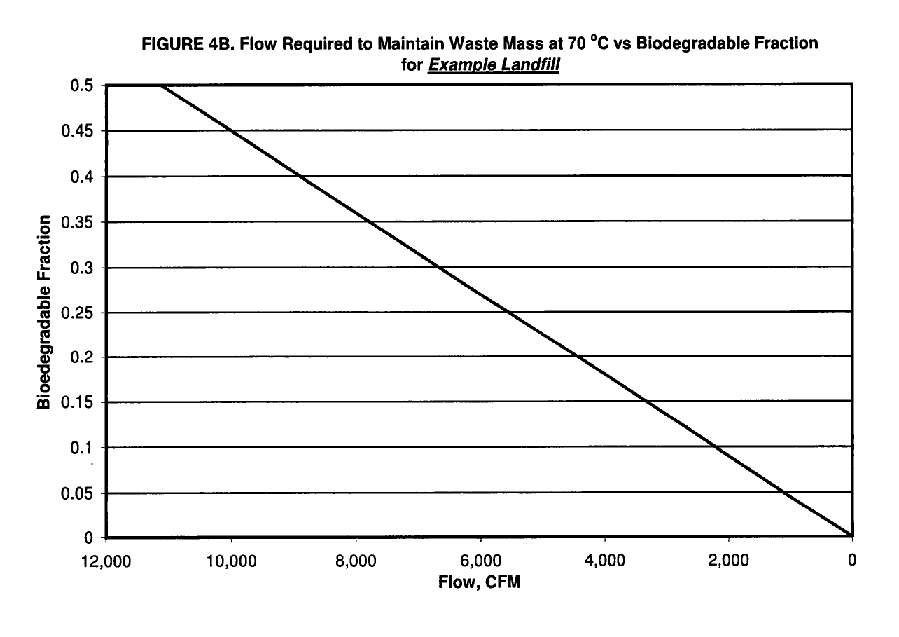

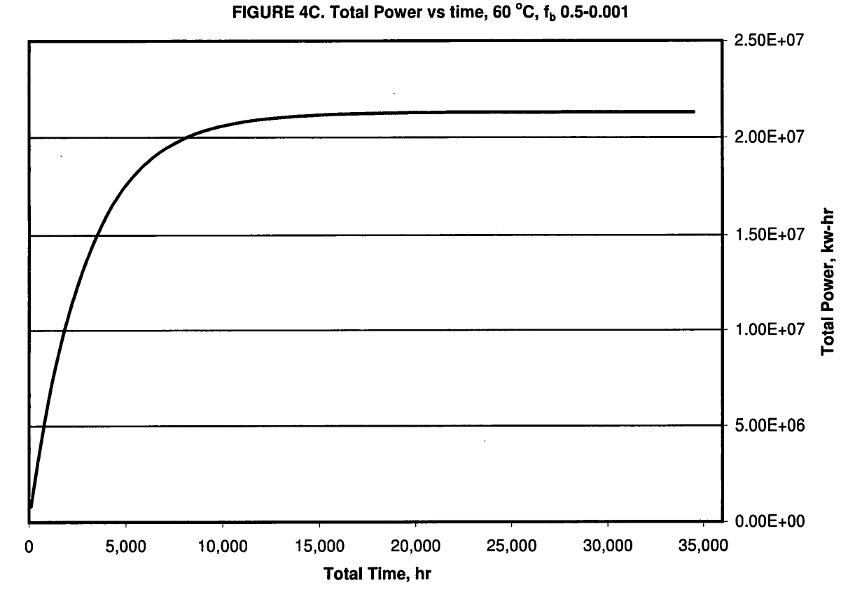

FIG. 4A is a graph of those flowrates necessary to maintain a temperature of 60° C. as the biodegradable fraction of the waste mass changes over time from 0.5 to 0.001.

FIG. 4B is a graph of those flowrates necessary to maintain a temperature of 70° C. as the biodegradable fraction of the waste mass changes over time from 0.5 to 0.001.

FIG. 4C is a graph showing the total power required versus time for maintaining the Example Landfill at a temperature of 60° C. as the biodegradable fraction varies from 0.5 to 0.001.

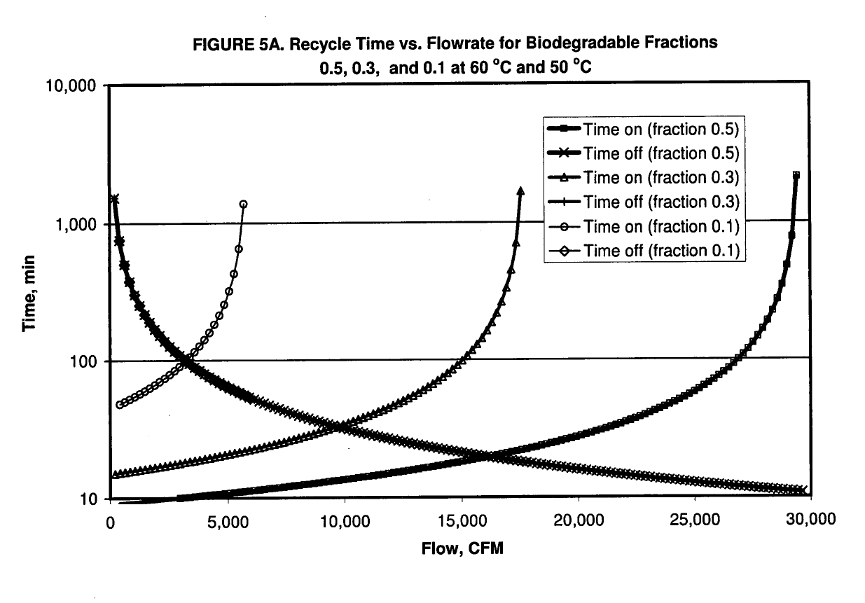

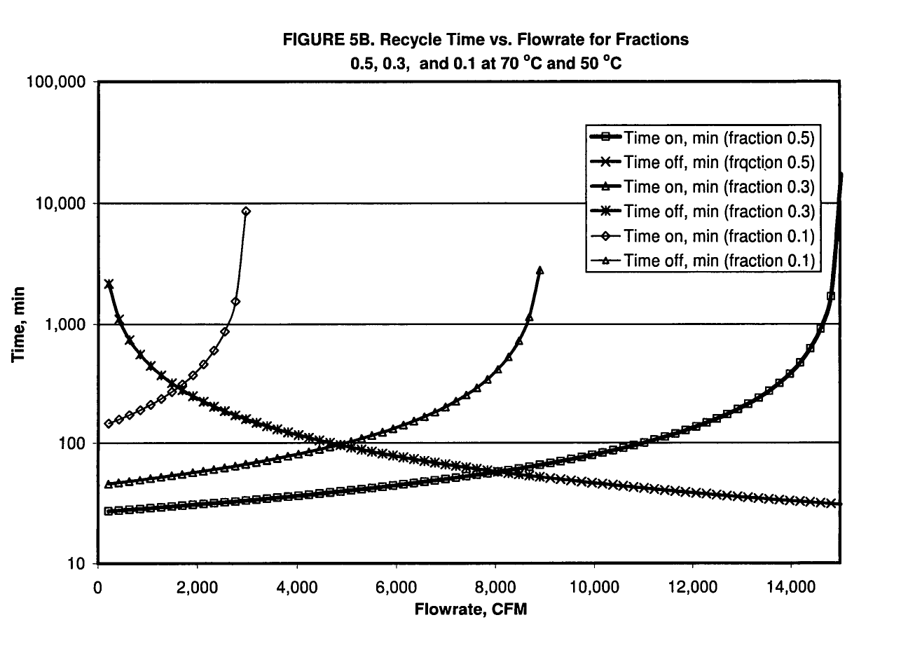

FIG. 5A is a graph of initial times versus flow rates for the first example in Table 8.

FIG. 5B is a graph of initial times versus flow rates for the second example in Table 8.

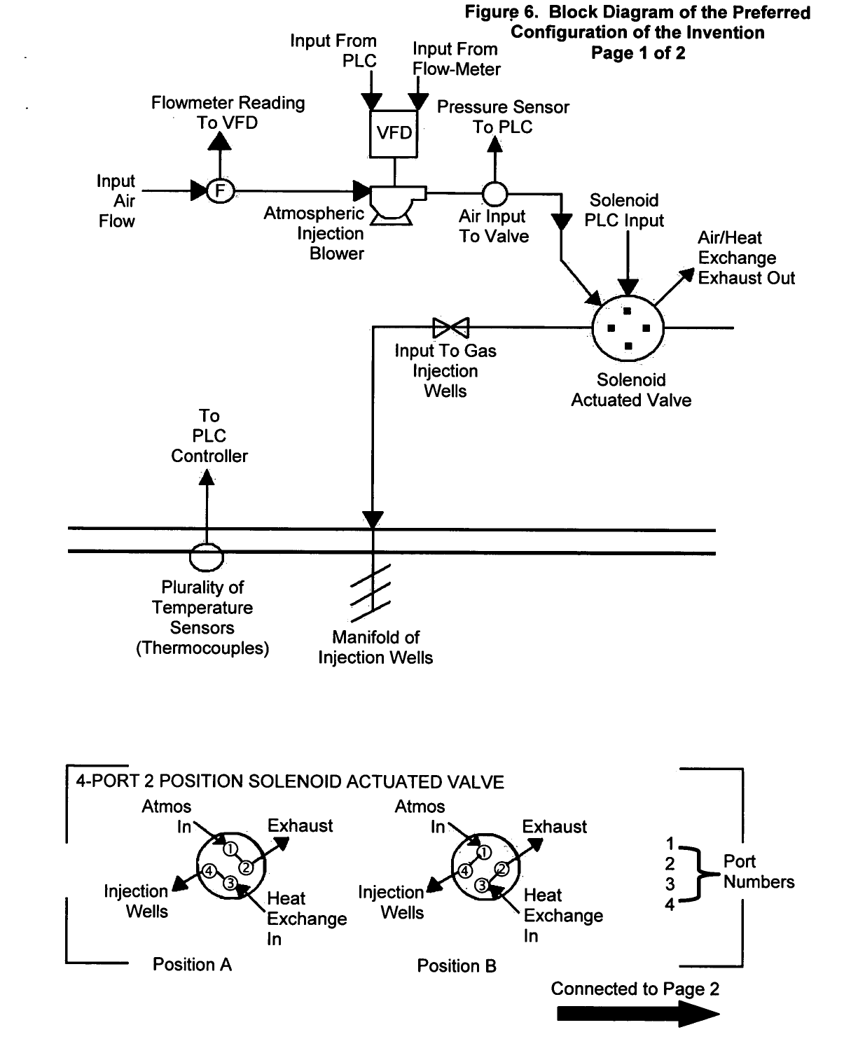

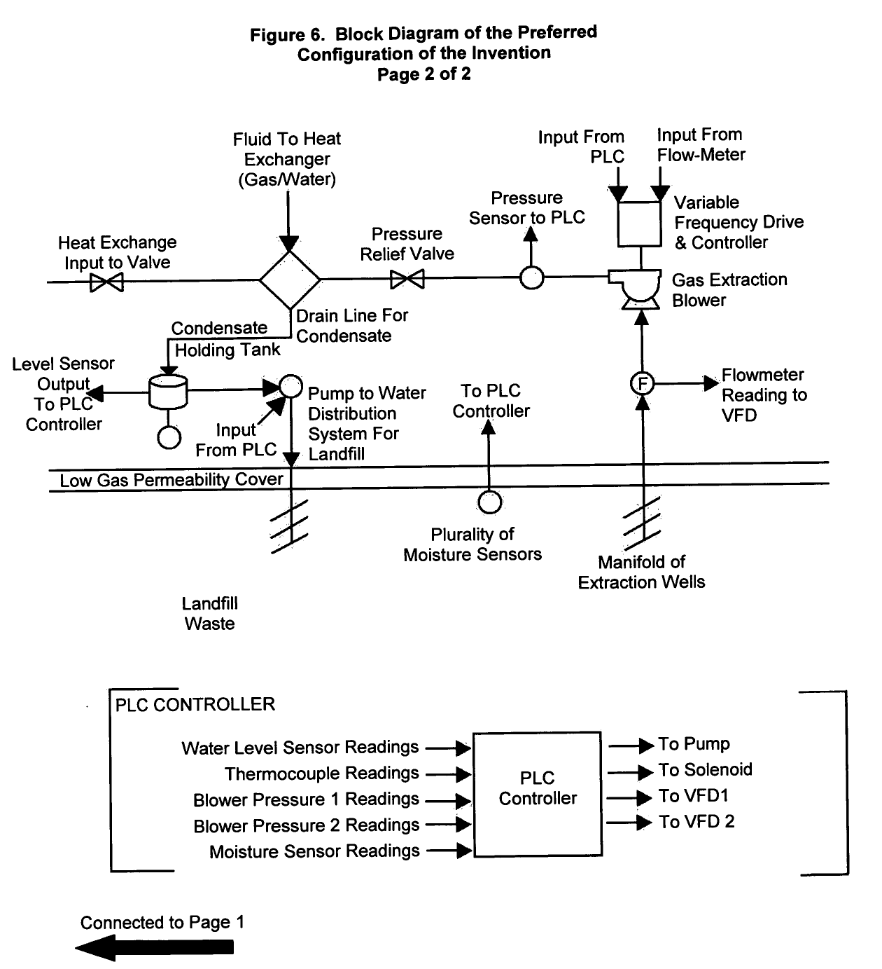

FIG. 6 is a schematic diagram of a landfill or landfill cell equipped with a preferred embodiment of the invention.

Table 1 lists the calculated data used to construct FIG. 1.

Table 2 uses a range of estimated aerobic reaction rates at 60° C. and employs the Arrhenius equation to calculate MSW aerobic reaction rates at other temperatures from 20 to 85° C., as discussed in the detailed description of the invention.

Table 3 calculates and lists the air flow rates required to maintain the Example Landfill at a given temperature assuming its waste mass biodegradable fraction is 0.5.

Table 4A calculates airflow rates necessary for the Example Landfill to maintain the temperature of the waste mass at a temperature of 60° C.

Table 4B calculates airflow rates necessary for the Example Landfill to maintain the temperature of the waste mass at a temperature of 70° C.

Table 5 lists the calculated values for power, time, and flowrates needed to maintain the Example Landfill at a temperature of 60° C. as the biodegradable fractions varies from 0.5 to 0.005.

Table 6 calculates and lists the parameters that make up the components of the constants K₁, K₂, and K₃ that are used for computational simplicity in the detailed description of the invention.

Table 7 is a list of properties for air and water used in the aerobic bioreactor calculations for the Example Landfill.

Table 8 contains sets of calculations for two example application of the invention using the Example Landfill given different initial operating times (recycle on; recycle off/atmospheric air on). The first example uses a minimum temperature of 50° C. and a maximum of 60° C. The second example uses a minimum temperature of 50° C. and a maximum of 70° C.

Table 9 is a tabulation of the power and time requirements to reduce the biodegradable fraction of the Example Landfill for 0.5 to 0.3 using recirculation to maintain the temperature between 50 and 60° C.

### DETAILED DESCRIPTION OF THE INVENTION

We describe the invention by first analytically calculating the air flow necessary to control the temperature using air alone without the aid of the invention. We then show that when the invention is employed, the air flow necessary to control the temperature of the waste mass may be lowered. Owing to the quadratic relation of the power required for a given airflow, lowering airflow substantially reduces both the power requirements and capital equipment costs for temperature control within the waste mass.

Definitions:

Note: A variable listed as Variable_{(T)}, for instance E_{(T)}, indicates the value of the variable for a given temperature T)

Fᵥ=Air flow rate through the waste mass, cm³-sec⁻¹

Ω=Volume of waste mass, cm³

E=Energy density of waste mass, erg-cm⁻³

E_{bio}=Energy generation rate from microbial action erg-sec⁻¹-cm⁻³

Eᵣ=Energy released during biodegradation, erg-gm⁻¹

f_{b}=Biodegradable organic fraction of solid waste

Lᵥ=Energy of vaporization for water, erg-gm⁻¹

ΔE₁=Change in energy density of waste mass during half of cycle, erg-cm⁻³

Δρᵥ=ρᵥₒᵤₜ−ρᵥᵢₙ=Difference of outflow vapor density minus inflow vapor density, gm-cm⁻³

Δe_{nc}=e_{ncout}−e_{ncin}, where e_{nc}=Energy density of the noncondensable gas component of the air flow through the waste mass, erg-cm⁻³

Δeᵥ=eᵥₒᵤₜ−eᵥᵢₙ, where eᵥ=Energy density of water vapor, erg-cm⁻³

Δeₗ=Energy in water added to the waste mass to maintain constant water content, erg-cm⁻³

C_{nc}=Heat capacity of the noncondensable component of the air flow through the waste mass, erg-gm⁻¹-° C.⁻¹

Cᵥ=Heat capacity of the vapor component of the air flowing through the waste mass, erg-gm⁻¹-° C.⁻¹

Cₗ=Heat capacity of the liquid water component within the waste mass, erg-gm⁻¹-° C.⁻¹

C_{w}=Heat capacity of the solid waste, erg-gm⁻¹-° C.⁻¹

T=Temperature, ° C.

Tₘₐₓ=Maximum temperature allowed, ° C.

T_{cool}=Lowest temperature during recirculation phase, ° C.

Tᵢₙ=Input temperature of oxygenated air when oxygen on, ° C.

Tₒᵤₜ=Temperature of effluent air from the waste mass, ° C. (=Tₘₐₓ for steady-state conditions)

T_{recyc}=Input temperature into waste mass of recirculated gas, ° C.

Tₗ=Temperature of added liquid water, ° C.

ρ_{nc}=Density of the noncondensable gas component of the air flowing through the waste mass, gm-cm⁻³

ρₗ=Density of water, gm-cm⁻³

ρᵥₛₐₜ=Density of water vapor in saturated air, gm-cm⁻³

ρ_{w}=Density of the solid waste, gm-cm⁻³

kᵣ=Biodegradation rate of waste mass, sec⁻¹

σ=Decimal value of water saturation of waste mass (1=100%); f=(1−σ)

ε=Decimal value of porosity

R_{Hrecycle}=Decimal value of relative humidity in recycle mode

R_{Hin}=Decimal value of relative humidity for injected atmospheric air

The relationships between the definitions are as follows (some of the relationships are provided for sake of completeness):

E_{(T)}=(1−ε)ρ_{w} C_{w}T+ε{σ ρₗCₗ^{T}+f[ρ_{nc}C_{nc}T+ρ_{vsat(T)}(CᵥT+Lᵥ)]}

Δ₁=E_{(Tmax)}−E_{(Tcool)}

E_{bio}=(1−ε)f_{b}ρ_{w}Eᵣk_{r(T)}

Δρᵥ=ρ_{vout(Tout)}−ρ_{vsat(Tin)}R_{Hin}

Δe_{nc}=ρ_{nc}C_{nc}(Tₒᵤₜ−Tᵢₙ)

Δeᵥ=Cᵥ(μ_{vsat(T)}Tₒᵤₜ−ρvsat(Tin)R_{Hin} Tᵢₙ)

Δeₗ=Cₗ(ρ_{vsat(Tout)}Tₒᵤₜ−ρ_{vsat(Tin)}R_{Hin} Tᵢₙ)

Ē_{bio}=(1−ε)f_{b}ρ_{w}Eᵣ·½(k_{r(Tmax)}+k_{r(Tcool)})

Δ̅e̅_{nc1}=ρ_{nc}C_{nc}( T̅−Tᵢₙ)

Δ̅e̅ᵥ₁=Cᵥ[½(ρ_{vsat(Tmax)}Tₘₐₓ+ρ_{vsat(Tcool)}T_{cool})−ρ_{vsat(Tin)}R_{Hin} Tᵢₙ]

Δ̅e̅ₗ₁=Cₗ[½(ρ_{vsat(Tmax)}+ρ_{vsat(Tcool)}) T̅−ρ_{vsat(Tin)}R_{Hin} Tᵢₙ]

Δ̅ρ̅ᵥ₁=½[(ρ_{vsat(Tmax)}+ρ_{vsat(Tcool)})−ρ_{vsat(Tin)}R_{Hin}]

Δ̅e̅_{nc2}=ρ_{nc}C_{nc}( T̅−T_{recycle})

T̅=½(Tₘₐₓ+T_{cool})

Δ̅e̅ᵥ₂=Cᵥ[½(ρ_{vsat(Tmax)}Tₘₐₓ+ρ_{vsat(Tcool)}T_{cool})−ρ_{vsat(Trecycle)}R_{Hrecycle} T_{recycle}]

Δ̅e̅ₗ₂=Cₗ[½(ρ_{vsat(Tmax)}+ρ_{vsat(Tcool)}) T̅−ρ_{vsat(Trecycle)}R_{Hrecycle} T_{recycle}]

Δ̅ρ̅ᵥ₂=½[(ρ_{vsat(Tmax)}+ρ_{vsat(Tcool)})−ρ_{vsat(Trecycle)}R_{Hrecycle}]

We now list a set of reasonable values for the given definitions in our analysis of airflow through a waste mass with and without use of the invention. We will use the same Example Landfill waste mass volume utilized in the discussion on power requirements, i.e.:

Ω=5.40×10⁴ m³=5.40×10 ¹⁰ cm³

Eᵣ=1.5×10¹¹ erg-gm⁻¹

f_{b}=0.5

Tₘₐₓ=Specified for each example.

T_{cool}=Specified for each example.

Tᵢₙ=25° C.

Tₒᵤₜ=Temperature of effluent air from the waste mass, ° C., equivalent to Tₘₐₓ

T_{recyc}=35° C. We assume heat exchanger efficiency specifications are cooling to 10° C. or less above ambient air temperature (Tᵢₙ).

Tₗ=25° C.

C_{nc}˜7.2×10⁶ erg-gm⁻¹-° C.⁻¹

Cᵥ≈1.3×10⁷ erg-gm-⁻¹-° C.⁻¹

Cₗ=4.2×10⁷ erg-gm-⁻¹-° C.⁻¹

C_{w}=8.37×10⁴ erg-gm-⁻¹-° C.⁻¹

Lᵥ=2.26×10¹⁰ erg-gm⁻¹

ρ_{nc}˜10⁻³ gm-cm⁻³

ρₗ=Density of water, 1 gm-cm⁻³

ρ_{vsat(T)} Taken from Table 6, gm-cm⁻³ for each Tₘₐₓ and T_{cool}.

ρ_{vsat25° C.}=(Table 6) 2.32×10⁻⁵ gm-cm⁻³; for assumed ambient (input from atmosphere) temperature.

ρ_{vsat35° C.}=(Table6) 3.99×10⁻⁵ gm-cm⁻³; for assumed recycle (input from heat exchanger) temperature

R_{Hin}=0.30

R_{Hrecycle}=1.0

ρ_{w}=0.4 gm-cm⁻³

k_{r60° C.}=5.0×10⁻⁸ sec⁻¹

k_{r50° C.}=2.5×10⁻⁸ sec⁻¹

σ=0.30; f=(1−σ)=0.70

ε=0.45

Chemical reaction rates are normally a function of temperature. A useful method of expressing the effect of temperature on a reaction rate is to compare the measured reaction rate at one temperature to the rate at a temperature 10° C. lower. This ratio is called the temperature coefficient Q₁₀. For biological chemical reactions (such as waste degradation in landfills) that are not diffusion controlled, an approximate doubling of the reaction rate kᵣ for each 10° C. increase is observed (i.e., Q₁₀=2) over the narrow temperature range necessary for living organisms to metabolize. This effect holds until the temperature for the maximum rate is reached, above which point the rate will decline, generally with the same Q₁₀, until the organisms are inactivated by temperature. The Arrhenius equation is a mathematical relationship between temperature and the rate of reaction, which we express here in integrated form:

$$ln \frac{{k}_{r 2}}{{k}_{r 1}} = \frac{{E}_{a} ( {T}_{2} - {T}_{1} )}{{RT}_{2} {T}_{1}} \qquad ( 2 )$$

where kᵣ₂ and kᵣ₁ are the reaction rates at absolute temperatures T₂ and T₁, respectively, R the gas constant, and Eₐ the activation energy for the reaction in cal-mol⁻¹. The activation energy is the amount of energy required by a molecule to undergo a chemical reaction. Biological systems operate over a limited temperature range. A range of 10 to 85° C. corresponds to a range of only 283 to 358 K, with the product of T₁ and T₂ changing only slightly over this range. It is therefore reasonable to assume that

$$\frac{{E}_{a}}{{RT}_{2} {T}_{1}}$$

is constant over the temperature range of typical biological systems, allowing Equation (2) to be written as:

kᵣ₂=kᵣ₁e^{φ(T}^{₂}^{-T}^{₁}⁾ (3)

A Q₁₀ of 2 is equivalent to a φ of 0.069, with T₂>T₁. For temperatures above the maximum, T₁ and T₂ are reversed in the exponent, giving it a negative value and showing a decrease in reaction rate as the temperature increases.

Landfill waste reaction rates have been extensively studied by the solid waste industry with evidence strongly indicating a first-order rate equation of the form

$$\frac{d {f}_{b} Ω}{d t} = - {k}_{r} {f}_{b} Ω \qquad ( 4 )$$

with the symbols as defined previously. The product f_{b}Ω represents the quantity of biodegradable solids in the volume of the waste mass, and the negative product of the two indicates that this quantity decreases over time. Expressing this equation in integral form, we have

$${\int }_{{f}_{bo}}^{{f}_{b}} \frac{d {f}_{b} Ω}{{f}_{b} Ω} = - {k}_{r} {\int }_{0}^{t} d t \qquad ( 5 )$$

where the integration limits are from an initial fraction f_{b0} to a final fraction f_{b}, and from and initial time of 0 to time t. Integration yields

$$t = \frac{1}{{k}_{r}} ln \frac{{f}_{b 0}}{{f}_{b}} \qquad ( 6 )$$

which is the time for a waste mass to decay under first-order kinetics from an original biodegradable fraction to a target fraction. Note that the time depends only on the ratio of initial and final fractions of biodegradable waste. In practical terms, Equation (6) states that whatever the amount of solid waste present, the time required to go from the same ratio of original and final fractions will be the same, regardless of whether the fractions are, for example, 0.5 and 0.1 or 0.005 and 0.001. Therefore, it is to the landfill operator's advantage to identify the highest fraction that may be left in place and degraded by natural processes (such as oxygen diffusion) that attenuate methane or biodegradable waste. Otherwise costs will increase by continuing to pass air through the system unnecessarily.

Biodegradation rates at a given temperature can vary from landfill to landfill, depending on the local conditions and the composition and age of the waste. For fresh MSW the optimum rate occurs at a temperature of approximately 60° C. If we have a determination of the biodegradation rate at that temperature, we may use Equation (3) to generate values for the reaction rate at the specific site for a range of anticipated temperatures, using the reasonable set of assumptions mentioned. The optimum rates at 60° C. are believed to lie between 10⁻⁷ and 10⁻⁸ sec⁻¹ for fresh MSW. Table 2 lists calculated reaction rates using five different maximum values at 60° C. for the temperature range 20 to 85° C. FIG. 2 is a curve generated from Equation (3) choosing a maximum rate at 60° C. of 5.0×10⁻⁸ sec⁻¹.

To demonstrate the usefulness of the invention, we now develop some example comparisons. One example maintains the temperature of a waste mass at a given temperature Tₘₐₓ using air alone to cool the waste mass. The second example maintains the temperature of the same waste mass between temperatures Tₘₐₓ and T_{cool} using the invention to provide both an atmospheric air cooling mode alone and a recycle mode which recirculates deoxygenated air through the waste mass. We also demonstrate that it is possible with the invention to specify the airflow rate at which the operator chooses to maintain the waste mass temperature. We then can compare power requirements for each case to show the substantial power savings created by the invention. We consider here an aerobic landfill, but those versed in the art will recognize the applicability of the invention to other waste masses, including those that are functioning anaerobically. In the anaerobic case, the airflow must always be in the recycle mode to prevent atmospheric-source oxygen from entering the recirculating gases.

For any actively biodegrading waste mass, an energy balance equation may be written which states in mathematical terms that the energy rate of change equals the biodegradation energy rate and the net flux of energy from gases, vapor, water, and evaporation:

$$Ω \frac{d E}{d t} = Ω \cdot {E}_{bio} - {F}_{v} ( Δ {e}_{nc} + Δ {e}_{v} - Δ {e}_{l} + {L}_{v} Δ {ρ}_{v} ) \qquad ( 7 )$$

In the above equation, Δeᵢ=eᵢₒᵤₜ−eᵢᵢₙ

Case I: with the oxygen (from atmospheric air) always on, and the temperature maintained at a given level,

$$\begin{matrix}Ω \frac{d E}{d t} = 0 ; then {F}_{v} / Ω = {E}_{bio} / ( Δ {e}_{nc} + Δ {e}_{v} - Δ {e}_{l} + {L}_{v} Δ {ρ}_{v} ) \\ or & ( 8 ) \\ {F}_{v} = Ω {E}_{bio} / ( Δ {e}_{nc} + Δ {e}_{v} - Δ {e}_{l} + {L}_{v} Δ {ρ}_{v} ) & ( 9 )\end{matrix}$$

since (Δe_{nc}+Δeᵥ−Δeₗ+Lᵥ Δρᵥ) is a constant for a given set of temperatures, we can represent this term as a constant, K₃, reducing the expression to

Fᵥ=ΩE_{bio}/K₃ (10)

The value for the constant K₃ is given in Table 3 for different temperatures. Biodegradation of solid waste takes place over a range of temperatures. Biodegradation is appreciable at temperatures from as low as 10° C. to perhaps as high as 75° C. or possibly even higher. Therefore the operator of the landfill or other waste mass has the option of operating the invention at lower minimum and higher maximum temperatures than are given here. For example, running a system at a maximum temperature of 70° C., should such a temperature be feasible under the given circumstances, will reduce the biodegradation rate and therefore the heat generated by biodegradation. Additionally, the higher temperature will provide more efficient heat removal because, in the temperature range of 40 to 90° C., a 10° C. increase in air temperature approximately doubles the water-vapor holding capacity of the air flowing through the waste mass. Conversely, it may be advantageous to have a lower minimum temperature when recycling oxygen-depleted air through the landfill. In the anaerobic case, lower gas flow and lower temperatures may be determined to be preferable to improve gas generation rates for the specific circumstances of the waste mass. Hence the invention has potential applicability for a wide range of temperature minima and maxima.

Table 3 provides the calculated flow rates required to maintain the example landfill at a given temperatures with atmospheric air constantly injected. The values for K₃ are also given for each temperature. FIG. 3 presents a curve generated from the values in the table, which uses 5° C. intervals as data points. Note, as mentioned above, the substantial difference between the required flow rates for 60° C. (the optimum temperature for biodegradation) and for 70° C., resulting from both the greater cooling effects at 70° C. and the reduction of the reaction rate with increasing temperature.

An important fact that demonstrates a utility of the invention is that as the biodegradable fraction of the waste is reduced, the flow rate needed to maintain the landfill at a desired temperature is also reduced. This is because the Ebio term in equations (8) through (10) is a function of both the biodegradable fraction f_{b} and the biodegradation rate of the waste mass kᵣ. While the rate remains constant at a given temperature, the biodegradable fraction decreases over time, and thus lowers the value of Ebio. As illustrative examples, Table 4A presents the calculated flow rates required to maintain the temperature of the waste at 60° C., the optimum biodegradation temperature for fresh MSW, as the fraction of biodegradable waste is reduced from 0.5 to 0.001. Table 4B presents the calculated flow rates for the same variables at 70° C. FIG. 4A is the curve generated for 60° C., and FIG. 4B is the curve for 70° C. Reduction of the biodegradable fraction to a value as low as 0.001 is not usually necessary, since at a higher fraction than that value (˜0.004 to as much as 0.01) enough oxygen can diffuse into the waste mass to oxidize the remaining methane generated. Those versed in the art will recognize that the lowered flow rate requirements to maintain a given temperature of the waste mass indicate the most cost-effective way to proceed: programmed lowering of the flow rate over time as the residual biodegradable fraction is reduced. Initially a high rate is required to maintain the target temperature. A utility of the invention is its ability to reduce the required flow rate when the biodegradable fraction is at its maximum value. This reduction in the initial high flow rate can substantially lower the capital costs by decreasing the necessary blower capacity as well as reducing the power costs which, as noted earlier (see Table 1), rise quadratically with the flow rate.

Since flow rate is related to pressure and thus power requirements, and since the biodegradable fraction can be expressed in terms of the time, we can also determine the total power requirements and the time required to reach a target biodegradable fraction. This is shown in FIG. 4C and calculated in Table 5 for a maintained temperature of 60° C. FIG. 4C is essentially FIG. 4A re-expressed in terms of time and total power. Note the flattening out of the curve with increased time as the power requirements drop with the decreased flow rates.

Case II (with recycle): During a cycle, T increases from T_{cool} to Tₘₐₓ as oxygen is on, then back to T_{cool} when oxygen is turned off (recycling phase). It will be shown that with a specified flow rate, temperature range, and biodegradable fraction, we can determine tₒₙ (the time oxygen is circulating through the landfill) and t_{off} (time in the recycling phase).

During the period when oxygen is being supplied to the waste mass at a given flow rate, the expression for the waste mass to increase in temperature from an initial to a final T by a given amount over a time tₒₙ is

$$\{ {\overline{E}}_{bio} - [ ( \frac{{F}_{v}}{Ω} ) \cdot ( \begin{matrix}{\overline{Δ e}}_{nc 1} + {\overline{Δ e}}_{v 1} - \\ {\overline{Δ e}}_{l 1} + {L}_{v} {\overline{Δ ρ}}_{v 1}\end{matrix} ) ] \} \frac{{t}_{on}}{{ρ}_{w} {C}_{w}} = Δ \underline{°} C . \qquad ( 10 )$$

The first term in the curly brackets represents the amount of energy that is being supplied by biodegradation; and the second, in square brackets within the curly brackets, is the rate at which energy is being carried away, both rates per unit volume. The approximation is made that the waste mass heats up at a uniform rate, which may not be true locally, but is approximately correct using the average of values over the entire landfill. Once again, Ē_{bio} is the term involving the biodegradable fraction, which will change over time, and the biodegradation rate, here given as (k_{r(Tmax)}+k_{r(Tcool)})½. This is less than the rate that biodegradation proceeds at constant temperature, since physically what is happening during the cycling is that the waste mass heats up to its target maximum, and then the oxygen is shut off to allow it to cool to its target minimum. As a result the combined average rate is lower. Since the terms ( Δ̅e̅_{nc1}+ Δ̅e̅ᵥ₁− Δ̅e̅ₗ₁+Lᵥ Δ̅ρ̅ᵥ₁) are constant at a given set of temperatures, we identify them as a constant (K₁) for convenience in calculation, and the expression (10) becomes

$$\begin{matrix}\{ {\overline{E}}_{bio} - [ ( \frac{{F}_{v}}{Ω} ) \cdot {K}_{1} ] \} \frac{{t}_{on}}{{ρ}_{w} {C}_{w}} = Δ \underline{°} C . \\ and & ( 11 ) \\ {t}_{on} = {ρ}_{w} {C}_{w} ( Δ \underline{°} C . ) / [ {\overline{E}}_{bio} - ( \frac{{F}_{v}}{Ω} ) \cdot {K}_{1} ] & ( 12 )\end{matrix}$$

During the recycling period, when air from the waste mass is being recirculated through the waste mass at a given flow rate, the expression showing the decrease in temperature by a given amount over a time t_{off} is

$$- \{ [ ( \frac{{F}_{v}}{Ω} ) \cdot ( \begin{matrix}{\overline{Δ e}}_{nc 2} + {\overline{Δ e}}_{v 2} - \\ {\overline{Δ e}}_{l 2} + {L}_{v} {\overline{Δ ρ}}_{v 2}\end{matrix} ) ] \} \frac{{t}_{off}}{{ρ}_{w} {C}_{w}} = - Δ \underline{°} C . \qquad ( 13 )$$

Because no biodegradation is taking place, the expression represents only loss of heat energy over time (other than the added liquid, which is given an opposite sign). Since the terms ( Δ̅e̅_{nc2}+ Δ̅e̅ᵥ₂− Δ̅e̅ₗ₂+Lᵥ Δ̅ρ̅ᵥ₂) are also constant for a given set of temperatures, we label this expression K₂. Solving for t_{off},

$${t}_{off} = {ρ}_{w} {C}_{w} ( Δ \underline{°} C . ) / [ ( \frac{{F}_{v}}{Ω} ) \cdot {K}_{2} ] \qquad ( 14 )$$

Values for these constants are calculated in Table 6.

Both expressions for tₒₙ and t_{off} represent the initial times on and off for the original biodegradable fraction. As mentioned, this changes over time. We are free to pick a flow rate; once done, if that rate of air flow is continued until target biodegradable fraction is reached, the only variable that will affect the times is the biodegradable fraction in the expressions for tₒₙ. To demonstrate conceptually the utility of the invention, we first calculate the initial tₒₙ and t_{off} for different flow rates and initial biodegradable fractions for two different temperature ranges. We could take any number of sets of operating conditions in terms of T_{cool} and Tₘₐₓ, but for the purposes of illustration, we select two: T_{cool} and Tₘₐₓ at 50° C. and 60° C., respectively and T_{cool} and Tₘₐₓ at 50° C. and 70° C., respectively.

Using the two ranges of temperatures, we now calculate the operating conditions for each range in terms of tₒₙ and t_{off} for various flow rates in order to determine a cost-effective configuration in terms of energy usage. The flow rates needed to maintain a specified temperature for a waste mass with a given volume and biodegradable fraction, as presented in Table 3, are calculated based on the kᵣ at that temperature. A higher flow rate will cool the operating temperature of the landfill to below the target temperature. In our model, the expression for tₒₙ which contains Ē_{bio} uses the “effective kᵣ” of ½ (k_{r(Tmax)}+k_{r(Tcool)}) rather than the normal E_{bio} used in the equation calculating the flow necessary to maintain the waste mass at a specified temperature. This average value is used because the waste mass is heating up from an initially cooler temperature, which affects the reaction rate over the time the waste mass heats to the target maximum temperature.

Table 8 lists the initial operational tₒₙ and t_{off} for a range of selected flow rates for the Example Landfill waste mass with the minimum and maximum temperatures as above. It also lists the time required to completely degrade the landfill under a given set of operating conditions, and a specific biodegradable fraction. FIGS. 5A and 5B are the curves for the initial operational times versus flow rate for 50° C. and 60° C.; and 50° C. and 70° C., respectively. It should be pointed out that we are using the approximation that biodegradation begins instantaneously when the microbes are exposed to oxygen. In practice, there is a lag time that varies from case to case and results in a longer time for the waste mass to heat up than is calculated here. However, the lag time is normally short for aerobic landfill bioreactors, particularly if they have been anaerobic for relatively short times, and the assumption of instantaneous biodegradation restart is a reasonable approximation.

Numerous scenarios may be chosen by the landfill operator regarding how best to apply the invention. The choice depends on the optimal cost combination of capital, operating, and maintenance costs. These are dependent on site-specific conditions. Our analysis points toward a general approach of determining the various cost factors and then choosing the lowest practical initial flowrate. This approach will reduce the power and capital costs during the beginning phase of the aerobic treatment of the landfill. At some predetermined time, when the biodegradable fraction has reached a specified value, the landfill operator can switch to a continuous atmospheric air flow mode and take advantage of the higher biodegradation rate that occurs, thus reducing the remaining operational time while avoiding the higher initial power and capital costs. Such choices would need to be determined by numerical simulations as a preliminary engineering design step. Practitioners of the art will recognize such prior considerations, as well as other possible approaches, to the application of the invention.

We then present a concrete example using a specified flow rate and initial biodegradable fraction to show the savings in power and capital costs that the invention can provide when compared to a system that uses continuous air flow throughout. As our example, we compare the flow requirements and power required for two systems, using the Example Landfill. Both start with a biodegradable fraction of 0.5 and the target fraction is selected to be 0.005. One system uses continuous air flow to cool the waste mass and maintain the temperature at 60° C. The other system (the invention) uses a recycling mode to reduce the biodegradable fraction 0.5 to 0.3. It then switches to continuous air flow. From that point on, both systems use the same airflow and power to reach the target fraction of 0.005.

The system with continuous airflow must start with a higher flow rate in order to maintain the temperature at 60° C. The bioreaction rate is 5.0×10⁻⁸ sec⁻¹. As shown in Table 4A and FIGS. 4A and 4C, that initial flow rate is required to be 33,400 CFM. Upon reaching the target, the process has used 2.13×10⁷ kilowatt-hours of power, and has taken 3.06 years to do so.

For the invention, we choose an initial flowrate of 16,400 CFM. Table 9 indicates an initial time on of 22.4 minutes and an initial time off of 18.1 minutes. The power requirements to reach the 0.3 biodegradable fraction target are 7.58×10⁶ kilowatt-hours and the time to accomplish this is 0.476 years. At this point the continuous airflow process begins. To maintain a temperature of 60° C. from this point forward, we must increase the flowrate, since the bioreaction rate increases at a constant temperature of 60° C. We now follow the same power curve as the first system (Table 4A), going from an initial biodegradable fraction of 0.3 to the target fraction of 0.005. The reaction rate now becomes 5.0×10⁻⁸ sec⁻¹; identical to the first system. The flowrate must be adjusted to 20,000 CFM initially to maintain 60° C. The 0.005 target is reached by using an additional 7.40×10⁶ kilowatt-hours and 2.71 years. The total power consumption is then 1.50×10⁷ kilowatt-hours using the invention versus 2.13×10⁷ kilowatt-hours and 3.06 years versus 3.19 years for the two systems, respectively.

We believe this shows clearly by example the potential cost saving by using the invention in aerobic treatment of a waste mass. The lower capital costs are attained through reduction in needed blower capacity (20,000 CFM rather than 33,400 CFM) and savings in power costs, 6.30×10⁶ kilowatt-hours, while operating time is increased by less than two months.

A diagram of a preferred configuration of the invention apparatus in a landfill injection/extraction system is given in FIG. 6. Such a diagram could represent a configuration for a particular cell of the landfill, or for the complete landfill itself. Air is injected by a blower into the waste mass via a plurality of injection wells. It then migrates to a plurality of blower-operated extraction wells under the influence of both the injection system and the extraction system. As will be discussed below, the air supplied to the injection blower may be entirely atmospheric air, entirely recycled air from the waste mass, or a mixture of the two sources. The number of wells, their depths, and their configuration will have been previously determined by design and modeling practices known to those in the art. During its migration, the air accumulates moisture vapor that has been generated by the landfill waste as a result of biological or chemical decomposition. As a result, heat is carried away from the landfill waste mass, predominantly by the latent heat of vaporization of the liquid in the waste mass, but also by the increases in heat capacity of the flowing gas components. If enough heat is removed in this fashion, the waste mass can be stabilized at a given temperature, or may be cooled to a lower temperature. The migrating air is drawn from the subsurface by the previously mentioned extraction blower(s) operating on the plurality of extraction wells. The extraction blower passes the exhaust gases from the extraction wells through an apparatus functioning as a heat exchanger. During passage through the heat exchanging apparatus, the air is cooled, and releases moisture, which may be captured and sent to a holding tank for reinjection into the waste mass. Additional water can be injected when needed. The injection method is most efficiently pressurized drip irrigation, but other techniques may be used provided that care is taken to avoid creating significant near-water-saturated volumes within the waste mass.

After passing through the heat exchanger the air is directed to an apparatus, in this case a 4-port, 2-position solenoid-activated valve, which is actuated to either vent the exhaust gas to the atmosphere or to a processing unit such as activated carbon, or to direct the cooled exhaust back into the landfill via an injection blower. The injected exhaust may be completely or partially deoxygenated as a result of passing through the biodegrading landfill waste, thus either slowing or stopping completely the biodegradation taking place in the landfill waste. If the exhaust is vented to a location outside of the waste mass, fresh air is concurrently injected into the waste mass by the injection blower. Those who are versed in the art will recognize that a more sophisticated valving system can be used here to bleed fresh air into any exhaust gas reinjected into the landfill waste, thereby creating a mixture of fresh air and exhaust gases, should it be deemed necessary to add oxygen below its normal concentration in fresh air. They will also recognize that the recycling flow rate need not be the same as the injected air flow rate, in case a faster cooling rate is desired.

### REFERENCES

Engineering Toolbox Website http://www.engineeringtoolbox.com/
Haug, R., 1993. The Practical Handbook of Compost Engineering. Lewis Publishers, Boca Raton, Fla.
Hydro Geo Chem. 2003. Rio Nuevo Landfill Stabilization Project, Tucson, Arizona, Nearmont Landfill Pilot Test Report. Prepared for Environmental Services, City of Tucson, 100 N. Stone Avenue, 2 Floor, Tucson, Ariz. 85701, Sept. 30
Hyperphysics Tables, Georgia State University Website http://hyperphysics.phy-astr.gsu.edu/HBASE/hph.html

TABLE 1
Gas Flow vs. Power for Example Landfill

| Airflow Fᵥ | Fᵥ | ΔP | ΔP | FᵥΔP | Power Use |
|---|---|---|---|---|---|
| (ft³/min) | (m³/sec) | (Newton/m²) | (psi) | (watts) | (kilowatts) |
| 500 | 2.33E−01 | 7.07E+03 | 1.03E+00 | 1.65E+03 | 1.65E+00 |
| 1,000 | 4.67E−01 | 1.41E+04 | 2.05E+00 | 6.60E+03 | 6.60E+00 |
| 1,500 | 7.00E−01 | 2.12E+04 | 3.08E+00 | 1.48E+04 | 1.48E+01 |
| 2,000 | 9.33E−01 | 2.83E+04 | 4.10E+00 | 2.64E+04 | 2.64E+01 |
| 2,500 | 1.17E+00 | 3.54E+04 | 5.13E+00 | 4.12E+04 | 4.12E+01 |
| 3,000 | 1.40E+00 | 4.24E+04 | 6.15E+00 | 5.94E+04 | 5.94E+01 |
| 3,500 | 1.63E+00 | 4.95E+04 | 7.18E+00 | 8.08E+04 | 8.08E+01 |
| 4,000 | 1.87E+00 | 5.66E+04 | 8.20E+00 | 1.06E+05 | 1.06E+02 |
| 4,500 | 2.10E+00 | 6.36E+04 | 9.23E+00 | 1.34E+05 | 1.34E+02 |
| 5,000 | 2.33E+00 | 7.07E+04 | 1.03E+01 | 1.65E+05 | 1.65E+02 |
| 5,500 | 2.57E+00 | 7.78E+04 | 1.13E+01 | 2.00E+05 | 2.00E+02 |
| 6,000 | 2.80E+00 | 8.48E+04 | 1.23E+01 | 2.38E+05 | 2.38E+02 |
| 6,500 | 3.03E+00 | 9.19E+04 | 1.33E+01 | 2.79E+05 | 2.79E+02 |
| 7,000 | 3.27E+00 | 9.90E+04 | 1.44E+01 | 3.23E+05 | 3.23E+02 |
| 7,500 | 3.50E+00 | 1.06E+05 | 1.54E+01 | 3.71E+05 | 3.71E+02 |
| 8,000 | 3.73E+00 | 1.13E+05 | 1.64E+01 | 4.22E+05 | 4.22E+02 |
| 8,500 | 3.97E+00 | 1.20E+05 | 1.74E+01 | 4.77E+05 | 4.77E+02 |
| 9,000 | 4.20E+00 | 1.27E+05 | 1.85E+01 | 5.35E+05 | 5.35E+02 |
| 9,500 | 4.43E+00 | 1.34E+05 | 1.95E+01 | 5.96E+05 | 5.96E+02 |
| 10,000 | 4.67E+00 | 1.41E+05 | 2.05E+01 | 6.60E+05 | 6.60E+02 |
| 10,500 | 4.90E+00 | 1.48E+05 | 2.15E+01 | 7.28E+05 | 7.28E+02 |
| 11,000 | 5.13E+00 | 1.56E+05 | 2.26E+01 | 7.99E+05 | 7.99E+02 |
| 11,500 | 5.37E+00 | 1.63E+05 | 2.36E+01 | 8.73E+05 | 8.73E+02 |
| 12,000 | 5.60E+00 | 1.70E+05 | 2.46E+01 | 9.50E+05 | 9.50E+02 |
| 12,500 | 5.83E+00 | 1.77E+05 | 2.56E+01 | 1.03E+06 | 1.03E+03 |
| 13,000 | 6.07E+00 | 1.84E+05 | 2.67E+01 | 1.12E+06 | 1.12E+03 |
| 13,500 | 6.30E+00 | 1.91E+05 | 2.77E+01 | 1.20E+06 | 1.20E+03 |
| 14,000 | 6.53E+00 | 1.98E+05 | 2.87E+01 | 1.29E+06 | 1.29E+03 |
| 14,500 | 6.77E+00 | 2.05E+05 | 2.97E+01 | 1.39E+06 | 1.39E+03 |
| 15,000 | 7.00E+00 | 2.12E+05 | 3.08E+01 | 1.48E+06 | 1.48E+03 |
| 15,500 | 7.23E+00 | 2.19E+05 | 3.18E+01 | 1.59E+06 | 1.59E+03 |
| 16,000 | 7.47E+00 | 2.26E+05 | 3.28E+01 | 1.69E+06 | 1.69E+03 |
| 16,500 | 7.70E+00 | 2.33E+05 | 3.38E+01 | 1.80E+06 | 1.80E+03 |
| 17,000 | 7.93E+00 | 2.40E+05 | 3.49E+01 | 1.91E+06 | 1.91E+03 |
| 17,500 | 8.17E+00 | 2.47E+05 | 3.59E+01 | 2.02E+06 | 2.02E+03 |
| 18,000 | 8.40E+00 | 2.55E+05 | 3.69E+01 | 2.14E+06 | 2.14E+03 |
| 18,500 | 8.63E+00 | 2.62E+05 | 3.79E+01 | 2.26E+06 | 2.26E+03 |
| 19,000 | 8.87E+00 | 2.69E+05 | 3.90E+01 | 2.38E+06 | 2.38E+03 |
| 19,500 | 9.10E+00 | 2.76E+05 | 4.00E+01 | 2.51E+06 | 2.51E+03 |
| 20,000 | 9.33E+00 | 2.83E+05 | 4.10E+01 | 2.64E+06 | 2.64E+03 |
| 20,500 | 9.57E+00 | 2.90E+05 | 4.20E+01 | 2.77E+06 | 2.77E+03 |
| 21,000 | 9.80E+00 | 2.97E+05 | 4.31E+01 | 2.91E+06 | 2.91E+03 |
| 21,500 | 1.00E+01 | 3.04E+05 | 4.41E+01 | 3.05E+06 | 3.05E+03 |
| 22,000 | 1.03E+01 | 3.11E+05 | 4.51E+01 | 3.19E+06 | 3.19E+03 |
| 22,500 | 1.05E+01 | 3.18E+05 | 4.61E+01 | 3.34E+06 | 3.34E+03 |
| 23,000 | 1.07E+01 | 3.25E+05 | 4.72E+01 | 3.49E+06 | 3.49E+03 |
| 23,500 | 1.10E+01 | 3.32E+05 | 4.82E+01 | 3.64E+06 | 3.64E+03 |
| 24,000 | 1.12E+01 | 3.39E+05 | 4.92E+01 | 3.80E+06 | 3.80E+03 |
| 24,500 | 1.14E+01 | 3.46E+05 | 5.02E+01 | 3.96E+06 | 3.96E+03 |
| 25,000 | 1.17E+01 | 3.54E+05 | 5.13E+01 | 4.12E+06 | 4.12E+03 |
| 25,500 | 1.19E+01 | 3.61E+05 | 5.23E+01 | 4.29E+06 | 4.29E+03 |
| 26,000 | 1.21E+01 | 3.68E+05 | 5.33E+01 | 4.46E+06 | 4.46E+03 |
| 26,500 | 1.24E+01 | 3.75E+05 | 5.43E+01 | 4.63E+06 | 4.63E+03 |
| 27,000 | 1.26E+01 | 3.82E+05 | 5.54E+01 | 4.81E+06 | 4.81E+03 |
| 27,500 | 1.28E+01 | 3.89E+05 | 5.64E+01 | 4.99E+06 | 4.99E+03 |
| 28,000 | 1.31E+01 | 3.96E+05 | 5.74E+01 | 5.17E+06 | 5.17E+03 |
| 28,500 | 1.33E+01 | 4.03E+05 | 5.84E+01 | 5.36E+06 | 5.36E+03 |
| 29,000 | 1.35E+01 | 4.10E+05 | 5.95E+01 | 5.55E+06 | 5.55E+03 |
| 29,500 | 1.38E+01 | 4.17E+05 | 6.05E+01 | 5.74E+06 | 5.74E+03 |
| 30,000 | 1.40E+01 | 4.24E+05 | 6.15E+01 | 5.94E+06 | 5.94E+03 |
| 30,500 | 1.42E+01 | 4.31E+05 | 6.25E+01 | 6.14E+06 | 6.14E+03 |
| 31,000 | 1.45E+01 | 4.38E+05 | 6.36E+01 | 6.34E+06 | 6.34E+03 |
| 31,500 | 1.47E+01 | 4.45E+05 | 6.46E+01 | 6.55E+06 | 6.55E+03 |
| 32,000 | 1.49E+01 | 4.53E+05 | 6.56E+01 | 6.76E+06 | 6.76E+03 |
| 32,500 | 1.52E+01 | 4.60E+05 | 6.66E+01 | 6.97E+06 | 6.97E+03 |
| 33,000 | 1.54E+01 | 4.67E+05 | 6.77E+01 | 7.19E+06 | 7.19E+03 |
| 33,500 | 1.56E+01 | 4.74E+05 | 6.87E+01 | 7.41E+06 | 7.41E+03 |
| 34,000 | 1.59E+01 | 4.81E+05 | 6.97E+01 | 7.63E+06 | 7.63E+03 |
| 34,500 | 1.61E+01 | 4.88E+05 | 7.07E+01 | 7.85E+06 | 7.85E+03 |
| 35,000 | 1.63E+01 | 4.95E+05 | 7.18E+01 | 8.08E+06 | 8.08E+03 |
| 35,500 | 1.66E+01 | 5.02E+05 | 7.28E+01 | 8.32E+06 | 8.32E+03 |
| 36,000 | 1.68E+01 | 5.09E+05 | 7.38E+01 | 8.55E+06 | 8.55E+03 |
| 36,500 | 1.70E+01 | 5.16E+05 | 7.48E+01 | 8.79E+06 | 8.79E+03 |

Title: Method and system for controlling biodegradation and temperature in an aerobic or anaerobic subsurface or partially enclosed waste mass.
Inventors: Harold W. Bentley and Richard W. Bentley

TABLE 2
Estimated Aerobic MSW Biodegradation Rates from 20 to 85° C.

| T (° C.) | kᵣ₆₀ = 1.0 × 10⁻⁸ | kᵣ₆₀ = 2.5 × 10⁻⁸ | kᵣ₆₀ = 5.0 × 10⁻⁸ | kᵣ₆₀ = 7.5 × 10⁻⁸ | kᵣ₆₀ = 1.0 × 10⁻⁷ |
|---|---|---|---|---|---|
| 20 | 6.33E−10 | 1.58E−09 | 3.16E−09 | 4.75E−09 | 6.33E−09 |
| 21 | 6.78E−10 | 1.70E−09 | 3.39E−09 | 5.09E−09 | 6.78E−09 |
| 22 | 7.27E−10 | 1.82E−09 | 3.63E−09 | 5.45E−09 | 7.27E−09 |
| 23 | 7.78E−10 | 1.95E−09 | 3.89E−09 | 5.84E−09 | 7.78E−09 |
| 24 | 8.34E−10 | 2.09E−09 | 4.17E−09 | 6.26E−09 | 8.34E−09 |
| 25 | 8.94E−10 | 2.23E−09 | 4.47E−09 | 6.70E−09 | 8.94E−09 |
| 26 | 9.58E−10 | 2.39E−09 | 4.79E−09 | 7.18E−09 | 9.58E−09 |
| 27 | 1.03E−09 | 2.56E−09 | 5.13E−09 | 7.69E−09 | 1.03E−08 |
| 28 | 1.10E−09 | 2.75E−09 | 5.50E−09 | 8.24E−09 | 1.10E−08 |
| 29 | 1.18E−09 | 2.94E−09 | 5.89E−09 | 8.83E−09 | 1.18E−08 |
| 30 | 1.26E−09 | 3.15E−09 | 6.31E−09 | 9.46E−09 | 1.26E−08 |
| 31 | 1.35E−09 | 3.38E−09 | 6.76E−09 | 1.01E−08 | 1.35E−08 |
| 32 | 1.45E−09 | 3.62E−09 | 7.24E−09 | 1.09E−08 | 1.45E−08 |
| 33 | 1.55E−09 | 3.88E−09 | 7.76E−09 | 1.16E−08 | 1.55E−08 |
| 34 | 1.66E−09 | 4.16E−09 | 8.31E−09 | 1.25E−08 | 1.66E−08 |
| 35 | 1.78E−09 | 4.45E−09 | 8.91E−09 | 1.34E−08 | 1.78E−08 |
| 36 | 1.91E−09 | 4.77E−09 | 9.55E−09 | 1.43E−08 | 1.91E−08 |
| 37 | 2.05E−09 | 5.11E−09 | 1.02E−08 | 1.53E−08 | 2.05E−08 |
| 38 | 2.19E−09 | 5.48E−09 | 1.10E−08 | 1.64E−08 | 2.19E−08 |
| 39 | 2.35E−09 | 5.87E−09 | 1.17E−08 | 1.76E−08 | 2.35E−08 |
| 40 | 2.52E−09 | 6.29E−09 | 1.26E−08 | 1.89E−08 | 2.52E−08 |
| 41 | 2.70E−09 | 6.74E−09 | 1.35E−08 | 2.02E−08 | 2.70E−08 |
| 42 | 2.89E−09 | 7.22E−09 | 1.44E−08 | 2.17E−08 | 2.89E−08 |
| 43 | 3.09E−09 | 7.74E−09 | 1.55E−08 | 2.32E−08 | 3.09E−08 |
| 44 | 3.32E−09 | 8.29E−09 | 1.66E−08 | 2.49E−08 | 3.32E−08 |
| 45 | 3.55E−09 | 8.88E−09 | 1.78E−08 | 2.66E−08 | 3.55E−08 |
| 46 | 3.81E−09 | 9.52E−09 | 1.90E−08 | 2.85E−08 | 3.81E−08 |
| 47 | 4.08E−09 | 1.02E−08 | 2.04E−08 | 3.06E−08 | 4.08E−08 |
| 48 | 4.37E−09 | 1.09E−08 | 2.18E−08 | 3.28E−08 | 4.37E−08 |
| 49 | 4.68E−09 | 1.17E−08 | 2.34E−08 | 3.51E−08 | 4.68E−08 |
| 50 | 5.02E−09 | 1.25E−08 | 2.51E−08 | 3.76E−08 | 5.02E−08 |
| 51 | 5.37E−09 | 1.34E−08 | 2.69E−08 | 4.03E−08 | 5.37E−08 |
| 52 | 5.76E−09 | 1.44E−08 | 2.88E−08 | 4.32E−08 | 5.76E−08 |
| 53 | 6.17E−09 | 1.54E−08 | 3.08E−08 | 4.63E−08 | 6.17E−08 |
| 54 | 6.61E−09 | 1.65E−08 | 3.31E−08 | 4.96E−08 | 6.61E−08 |
| 55 | 7.08E−09 | 1.77E−08 | 3.54E−08 | 5.31E−08 | 7.08E−08 |
| 56 | 7.59E−09 | 1.90E−08 | 3.79E−08 | 5.69E−08 | 7.59E−08 |
| 57 | 8.13E−09 | 2.03E−08 | 4.07E−08 | 6.10E−08 | 8.13E−08 |
| 58 | 8.71E−09 | 2.18E−08 | 4.36E−08 | 6.53E−08 | 8.71E−08 |
| 59 | 9.33E−09 | 2.33E−08 | 4.67E−08 | 7.00E−08 | 9.33E−08 |
| 60 | 1.00E−08 | 2.50E−08 | 5.00E−08 | 7.50E−08 | 1.00E−07 |
| 61 | 9.33E−09 | 2.33E−08 | 4.67E−08 | 7.00E−08 | 9.33E−08 |
| 62 | 8.71E−09 | 2.18E−08 | 4.36E−08 | 6.53E−08 | 8.71E−08 |
| 63 | 8.13E−09 | 2.03E−08 | 4.07E−08 | 6.10E−08 | 8.13E−08 |
| 64 | 7.59E−09 | 1.90E−08 | 3.79E−08 | 5.69E−08 | 7.59E−08 |
| 65 | 7.08E−09 | 1.77E−08 | 3.54E−08 | 5.31E−08 | 7.08E−08 |
| 66 | 6.61E−09 | 1.65E−08 | 3.31E−08 | 4.96E−08 | 6.61E−08 |
| 67 | 6.17E−09 | 1.54E−08 | 3.08E−08 | 4.63E−08 | 6.17E−08 |
| 68 | 5.76E−09 | 1.44E−08 | 2.88E−08 | 4.32E−08 | 5.76E−08 |
| 69 | 5.37E−09 | 1.34E−08 | 2.69E−08 | 4.03E−08 | 5.37E−08 |
| 70 | 5.02E−09 | 1.25E−08 | 2.51E−08 | 3.76E−08 | 5.02E−08 |
| 71 | 4.68E−09 | 1.17E−08 | 2.34E−08 | 3.51E−08 | 4.68E−08 |
| 72 | 4.37E−09 | 1.09E−08 | 2.18E−08 | 3.28E−08 | 4.37E−08 |
| 73 | 4.08E−09 | 1.02E−08 | 2.04E−08 | 3.06E−08 | 4.08E−08 |
| 74 | 3.81E−09 | 9.52E−09 | 1.90E−08 | 2.85E−08 | 3.81E−08 |
| 75 | 3.55E−09 | 8.88E−09 | 1.78E−08 | 2.66E−08 | 3.55E−08 |
| 76 | 3.32E−09 | 8.29E−09 | 1.66E−08 | 2.49E−08 | 3.32E−08 |
| 77 | 3.09E−09 | 7.74E−09 | 1.55E−08 | 2.32E−08 | 3.09E−08 |
| 78 | 2.89E−09 | 7.22E−09 | 1.44E−08 | 2.17E−08 | 2.89E−08 |
| 79 | 2.70E−09 | 6.74E−09 | 1.35E−08 | 2.02E−08 | 2.70E−08 |
| 80 | 2.52E−09 | 6.29E−09 | 1.26E−08 | 1.89E−08 | 2.52E−08 |
| 81 | 2.35E−09 | 5.87E−09 | 1.17E−08 | 1.76E−08 | 2.35E−08 |
| 82 | 2.19E−09 | 5.48E−09 | 1.10E−08 | 1.64E−08 | 2.19E−08 |
| 83 | 2.05E−09 | 5.11E−09 | 1.02E−08 | 1.53E−08 | 2.05E−08 |
| 84 | 1.91E−09 | 4.77E−09 | 9.55E−09 | 1.43E−08 | 1.91E−08 |
| 85 | 1.78E−09 | 4.45E−09 | 8.91E−09 | 1.34E−08 | 1.78E−08 |

Title: Method and system for controlling biodegradation and temperature in an aerobic or anaerobic subsurface or partially enclosed waste mass.
Inventors: Harold W. Bentley and Richard W. Bentley

TABLE 3
Flowrates Required to Maintain the Example Landfill at Specified Temperatures (° C.)

| | | | | | | | K₃ | | Fᵥ, | Fᵥ, |
|---|---|---|---|---|---|---|---|---|---|---|
| | | | | | | | (Δe_{nc} + Δeᵥ − | | cm³/sec to | ft³/min to |
| T | kᵣ | ρᵥₛₐₜ | Δρᵥ | Δe_{nc} | Δeᵥ | Δeₗ | Δeₗ + LᵥΔρᵥ) | E_{bio} | maintain | maintain |
| (° C.) | (sec⁻¹) | (gm/cm³) | (gm/cm³) | (erg/cm³) | (erg/cm³) | (erg/cm³) | (erg/cm³) | (erg/sec/cm³) | given T | given T |
| 20 | 3.16E−09 | 1.74E−05 | 1.05E−05 | −3.60E+04 | 2.27E+03 | 1.39E+04 | 1.89E+05 | 5.22E+01 | 1.49E+07 | 3.16E+04 |
| 25 | 4.47E−09 | 2.32E−05 | 1.63E−05 | 0.00E+00 | 5.29E+03 | 2.37E+04 | 3.49E+05 | 7.37E+01 | 1.14E+07 | 2.41E+04 |
| 30 | 6.31E−09 | 3.06E−05 | 2.37E−05 | 3.60E+04 | 9.68E+03 | 3.79E+04 | 5.42E+05 | 1.04E+02 | 1.04E+07 | 2.19E+04 |
| 35 | 8.91E−09 | 3.99E−05 | 3.30E−05 | 7.20E+04 | 1.59E+04 | 5.80E+04 | 7.75E+05 | 1.47E+02 | 1.02E+07 | 2.17E+04 |
| 40 | 1.26E−08 | 5.15E−05 | 4.46E−05 | 1.08E+05 | 2.45E+04 | 8.59E+04 | 1.05E+06 | 2.08E+02 | 1.06E+07 | 2.25E+04 |
| 45 | 1.78E−08 | 6.59E−05 | 5.89E−05 | 1.44E+05 | 3.63E+04 | 1.24E+05 | 1.39E+06 | 2.93E+02 | 1.14E+07 | 2.41E+04 |
| 50 | 2.51E−08 | 8.35E−05 | 7.66E−05 | 1.80E+05 | 5.20E+04 | 1.75E+05 | 1.79E+06 | 4.14E+02 | 1.25E+07 | 2.65E+04 |
| 55 | 3.54E−08 | 1.05E−04 | 9.80E−05 | 2.16E+05 | 7.28E+04 | 2.42E+05 | 2.26E+06 | 5.84E+02 | 1.39E+07 | 2.95E+04 |
| 60 | 5.00E−08 | 1.31E−04 | 1.24E−04 | 2.52E+05 | 9.98E+04 | 3.29E+05 | 2.82E+06 | 8.25E+02 | 1.58E+07 | 3.34E+04 |
| 65 | 3.54E−08 | 1.62E−04 | 1.55E−04 | 2.88E+05 | 1.35E+05 | 4.41E+05 | 3.48E+06 | 5.84E+02 | 9.06E+06 | 1.92E+04 |
| 70 | 2.51E−08 | 1.99E−04 | 1.92E−04 | 3.24E+05 | 1.79E+05 | 5.84E+05 | 4.25E+06 | 4.14E+02 | 5.25E+06 | 1.11E+04 |
| 75 | 1.78E−08 | 2.42E−04 | 2.35E−04 | 3.60E+05 | 2.34E+05 | 7.63E+05 | 5.15E+06 | 2.93E+02 | 3.07E+06 | 6.50E+03 |
| 80 | 1.26E−08 | 2.94E−04 | 2.87E−04 | 3.96E+05 | 3.03E+05 | 9.86E+05 | 6.19E+06 | 2.08E+02 | 1.81E+06 | 3.83E+03 |
| 85 | 8.91E−09 | 3.53E−04 | 3.46E−04 | 4.32E+05 | 3.88E+05 | 1.26E+06 | 7.39E+06 | 1.47E+02 | 1.07E+06 | 2.27E+03 |

Title: Method and system for controlling biodegradation and temperature in an aerobic or anaerobic subsurface or partially enclosed waste mass.
Inventors: Harold W. Bentley and Richard W. Bentley
Note that air flowrates greater than those needed to maintain the specified target temperature will result in a lower than target operating temperatures, in which case parameters given in the above Table 3 do not apply. Should a different kᵣ₆₀ be specified, different reaction rates will be generated for the listed temperatures which will result in a different set of flowrates and recyle times.

TABLE 4A and 4B
Flowrate Required to Maintain Cell at A: 60° C. and B: 70° C. as Biodegradable Fraction Changes

| 4A: T = 60° C. | | | | | | 4B: T = 70° C. | | | | | |
|---|---|---|---|---|---|---|---|---|---|---|---|
| | Bio- | Bio- | | | | | | Bio- | | | |
| | degradation | degradable | | | | | Biodegradation | degradable | | | |
| K₃ | Rate k | Fraction f_{b} | E_{bio} | Fᵥ | Fᵥ | K₃ | Rate k | Fraction f_{b} | E_{bio} | Fᵥ | Fᵥ |
| (erg/cm³) | (sec⁻¹) | (gm/gm) | (erg/cm³) | (cm³/sec) | (ft³/min) | (erg/cm³) | (sec⁻¹) | (gm/gm) | (erg/cm³) | (cm³/sec) | (ft³/min) |
| 2.82E+06 | 5.00E−08 | 0.500 | 8.25E+02 | 1.58E+07 | 3.34E+04 | 4.25E+06 | 2.51E−08 | 0.500 | 4.14E+02 | 5.25E+06 | 1.11E+04 |
| 2.82E+06 | 5.00E−08 | 0.490 | 8.09E+02 | 1.55E+07 | 3.27E+04 | 4.25E+06 | 2.51E−08 | 0.490 | 4.06E+02 | 5.15E+06 | 1.09E+04 |
| 2.82E+06 | 5.00E−08 | 0.480 | 7.92E+02 | 1.52E+07 | 3.21E+04 | 4.25E+06 | 2.51E−08 | 0.480 | 3.97E+02 | 5.04E+06 | 1.07E+04 |
| 2.82E+06 | 5.00E−08 | 0.470 | 7.76E+02 | 1.48E+07 | 3.14E+04 | 4.25E+06 | 2.51E−08 | 0.470 | 3.89E+02 | 4.94E+06 | 1.05E+04 |
| 2.82E+06 | 5.00E−08 | 0.460 | 7.59E+02 | 1.45E+07 | 3.07E+04 | 4.25E+06 | 2.51E−08 | 0.460 | 3.81E+02 | 4.83E+06 | 1.02E+04 |
| 2.82E+06 | 5.00E−08 | 0.450 | 7.43E+02 | 1.42E+07 | 3.01E+04 | 4.25E+06 | 2.51E−08 | 0.450 | 3.72E+02 | 4.73E+06 | 1.00E+04 |
| 2.82E+06 | 5.00E−08 | 0.440 | 7.26E+02 | 1.39E+07 | 2.94E+04 | 4.25E+06 | 2.51E−08 | 0.440 | 3.64E+02 | 4.62E+06 | 9.79E+03 |
| 2.82E+06 | 5.00E−08 | 0.430 | 7.10E+02 | 1.36E+07 | 2.87E+04 | 4.25E+06 | 2.51E−08 | 0.430 | 3.56E+02 | 4.52E+06 | 9.56E+03 |
| 2.82E+06 | 5.00E−08 | 0.420 | 6.93E+02 | 1.33E+07 | 2.81E+04 | 4.25E+06 | 2.51E−08 | 0.420 | 3.48E+02 | 4.41E+06 | 9.34E+03 |
| 2.82E+06 | 5.00E−08 | 0.410 | 6.77E+02 | 1.29E+07 | 2.74E+04 | 4.25E+06 | 2.51E−08 | 0.410 | 3.39E+02 | 4.31E+06 | 9.12E+03 |
| 2.82E+06 | 5.00E−08 | 0.400 | 6.60E+02 | 1.26E+07 | 2.67E+04 | 4.25E+06 | 2.51E−08 | 0.400 | 3.31E+02 | 4.20E+06 | 8.90E+03 |
| 2.82E+06 | 5.00E−08 | 0.390 | 6.44E+02 | 1.23E+07 | 2.61E+04 | 4.25E+06 | 2.51E−08 | 0.390 | 3.23E+02 | 4.10E+06 | 8.67E+03 |
| 2.82E+06 | 5.00E−08 | 0.380 | 6.27E+02 | 1.20E+07 | 2.54E+04 | 4.25E+06 | 2.51E−08 | 0.380 | 3.14E+02 | 3.99E+06 | 8.45E+03 |
| 2.82E+06 | 5.00E−08 | 0.370 | 6.11E+02 | 1.17E+07 | 2.47E+04 | 4.25E+06 | 2.51E−08 | 0.370 | 3.06E+02 | 3.89E+06 | 8.23E+03 |
| 2.82E+06 | 5.00E−08 | 0.360 | 5.94E+02 | 1.14E+07 | 2.41E+04 | 4.25E+06 | 2.51E−08 | 0.360 | 2.98E+02 | 3.78E+06 | 8.01E+03 |
| 2.82E+06 | 5.00E−08 | 0.350 | 5.78E+02 | 1.10E+07 | 2.34E+04 | 4.25E+06 | 2.51E−08 | 0.350 | 2.90E+02 | 3.68E+06 | 7.78E+03 |
| 2.82E+06 | 5.00E−08 | 0.340 | 5.61E+02 | 1.07E+07 | 2.27E+04 | 4.25E+06 | 2.51E−08 | 0.340 | 2.81E+02 | 3.57E+06 | 7.56E+03 |
| 2.82E+06 | 5.00E−08 | 0.330 | 5.45E+02 | 1.04E+07 | 2.20E+04 | 4.25E+06 | 2.51E−08 | 0.330 | 2.73E+02 | 3.47E+06 | 7.34E+03 |
| 2.82E+06 | 5.00E−08 | 0.320 | 5.28E+02 | 1.01E+07 | 2.14E+04 | 4.25E+06 | 2.51E−08 | 0.320 | 2.65E+02 | 3.36E+06 | 7.12E+03 |
| 2.82E+06 | 5.00E−08 | 0.310 | 5.12E+02 | 9.78E+06 | 2.07E+04 | 4.25E+06 | 2.51E−08 | 0.310 | 2.57E+02 | 3.26E+06 | 6.89E+03 |
| 2.82E+06 | 5.00E−08 | 0.300 | 4.95E+02 | 9.47E+06 | 2.00E+04 | 4.25E+06 | 2.51E−08 | 0.300 | 2.48E+02 | 3.15E+06 | 6.67E+03 |
| 2.82E+06 | 5.00E−08 | 0.290 | 4.79E+02 | 9.15E+06 | 1.94E+04 | 4.25E+06 | 2.51E−08 | 0.290 | 2.40E+02 | 3.05E+06 | 6.45E+03 |
| 2.82E+06 | 5.00E−08 | 0.280 | 4.62E+02 | 8.84E+06 | 1.87E+04 | 4.25E+06 | 2.51E−08 | 0.280 | 2.32E+02 | 2.94E+06 | 6.23E+03 |
| 2.82E+06 | 5.00E−08 | 0.270 | 4.46E+02 | 8.52E+06 | 1.80E+04 | 4.25E+06 | 2.51E−08 | 0.270 | 2.23E+02 | 2.84E+06 | 6.01E+03 |
| 2.82E+06 | 5.00E−08 | 0.260 | 4.29E+02 | 8.21E+06 | 1.74E+04 | 4.25E+06 | 2.51E−08 | 0.260 | 2.15E+02 | 2.73E+06 | 5.78E+03 |
| 2.82E+06 | 5.00E−08 | 0.250 | 4.13E+02 | 7.89E+06 | 1.67E+04 | 4.25E+06 | 2.51E−08 | 0.250 | 2.07E+02 | 2.63E+06 | 5.56E+03 |
| 2.82E+06 | 5.00E−08 | 0.240 | 3.96E+02 | 7.58E+06 | 1.60E+04 | 4.25E+06 | 2.51E−08 | 0.240 | 1.99E+02 | 2.52E+06 | 5.34E+03 |
| 2.82E+06 | 5.00E−08 | 0.230 | 3.80E+02 | 7.26E+06 | 1.54E+04 | 4.25E+06 | 2.51E−08 | 0.230 | 1.90E+02 | 2.42E+06 | 5.12E+03 |
| 2.82E+06 | 5.00E−08 | 0.220 | 3.63E+02 | 6.94E+06 | 1.47E+04 | 4.25E+06 | 2.51E−08 | 0.220 | 1.82E+02 | 2.31E+06 | 4.89E+03 |
| 2.82E+06 | 5.00E−08 | 0.210 | 3.47E+02 | 6.63E+06 | 1.40E+04 | 4.25E+06 | 2.51E−08 | 0.210 | 1.74E+02 | 2.21E+06 | 4.67E+03 |
| 2.82E+06 | 5.00E−08 | 0.200 | 3.30E+02 | 6.31E+06 | 1.34E+04 | 4.25E+06 | 2.51E−08 | 0.200 | 1.66E+02 | 2.10E+06 | 4.45E+03 |
| 2.82E+06 | 5.00E−08 | 0.190 | 3.14E+02 | 6.00E+06 | 1.27E+04 | 4.25E+06 | 2.51E−08 | 0.190 | 1.57E+02 | 2.00E+06 | 4.23E+03 |
| 2.82E+06 | 5.00E−08 | 0.180 | 2.97E+02 | 5.68E+06 | 1.20E+04 | 4.25E+06 | 2.51E−08 | 0.180 | 1.49E+02 | 1.89E+06 | 4.00E+03 |
| 2.82E+06 | 5.00E−08 | 0.170 | 2.81E+02 | 5.37E+06 | 1.14E+04 | 4.25E+06 | 2.51E−08 | 0.170 | 1.41E+02 | 1.79E+06 | 3.78E+03 |
| 2.82E+06 | 5.00E−08 | 0.160 | 2.64E+02 | 5.05E+06 | 1.07E+04 | 4.25E+06 | 2.51E−08 | 0.160 | 1.32E+02 | 1.68E+06 | 3.56E+03 |
| 2.82E+06 | 5.00E−08 | 0.150 | 2.47E+02 | 4.73E+06 | 1.00E+04 | 4.25E+06 | 2.51E−08 | 0.150 | 1.24E+02 | 1.58E+06 | 3.34E+03 |
| 2.82E+06 | 5.00E−08 | 0.140 | 2.31E+02 | 4.42E+06 | 9.35E+03 | 4.25E+06 | 2.51E−08 | 0.140 | 1.16E+02 | 1.47E+06 | 3.11E+03 |
| 2.82E+06 | 5.00E−08 | 0.130 | 2.14E+02 | 4.10E+06 | 8.69E+03 | 4.25E+06 | 2.51E−08 | 0.130 | 1.08E+02 | 1.37E+06 | 2.89E+03 |
| 2.82E+06 | 5.00E−08 | 0.120 | 1.98E+02 | 3.79E+06 | 8.02E+03 | 4.25E+06 | 2.51E−08 | 0.120 | 9.93E+01 | 1.26E+06 | 2.67E+03 |
| 2.82E+06 | 5.00E−08 | 0.110 | 1.81E+02 | 3.47E+06 | 7.35E+03 | 4.25E+06 | 2.51E−08 | 0.110 | 9.10E+01 | 1.16E+06 | 2.45E+03 |
| 2.82E+06 | 5.00E−08 | 0.100 | 1.65E+02 | 3.16E+06 | 6.68E+03 | 4.25E+06 | 2.51E−08 | 0.100 | 8.28E+01 | 1.05E+06 | 2.22E+03 |
| 2.82E+06 | 5.00E−08 | 0.090 | 1.48E+02 | 2.84E+06 | 6.01E+03 | 4.25E+06 | 2.51E−08 | 0.090 | 7.45E+01 | 9.46E+05 | 2.00E+03 |
| 2.82E+06 | 5.00E−08 | 0.080 | 1.32E+02 | 2.53E+06 | 5.35E+03 | 4.25E+06 | 2.51E−08 | 0.080 | 6.62E+01 | 8.40E+05 | 1.78E+03 |
| 2.82E+06 | 5.00E−08 | 0.070 | 1.16E+02 | 2.21E+06 | 4.68E+03 | 4.25E+06 | 2.51E−08 | 0.070 | 5.79E+01 | 7.35E+05 | 1.56E+03 |
| 2.82E+06 | 5.00E−08 | 0.060 | 9.90E+01 | 1.89E+06 | 4.01E+03 | 4.25E+06 | 2.51E−08 | 0.060 | 4.97E+01 | 6.30E+05 | 1.33E+03 |
| 2.82E+06 | 5.00E−08 | 0.050 | 8.25E+01 | 1.58E+06 | 3.34E+03 | 4.25E+06 | 2.51E−08 | 0.050 | 4.14E+01 | 5.25E+05 | 1.11E+03 |
| 2.82E+06 | 5.00E−08 | 0.040 | 6.60E+01 | 1.26E+06 | 2.67E+03 | 4.25E+06 | 2.51E−08 | 0.040 | 3.31E+01 | 4.20E+05 | 8.90E+02 |
| 2.82E+06 | 5.00E−08 | 0.030 | 4.95E+01 | 9.47E+05 | 2.00E+03 | 4.25E+06 | 2.51E−08 | 0.030 | 2.48E+01 | 3.15E+05 | 6.67E+02 |
| 2.82E+06 | 5.00E−08 | 0.020 | 3.30E+01 | 6.31E+05 | 1.34E+03 | 4.25E+06 | 2.51E−08 | 0.020 | 1.66E+01 | 2.10E+05 | 4.45E+02 |
| 2.82E+06 | 5.00E−08 | 0.010 | 1.65E+01 | 3.16E+05 | 6.68E+02 | 4.25E+06 | 2.51E−08 | 0.010 | 8.28E+00 | 1.05E+05 | 2.22E+02 |
| 2.82E+06 | 5.00E−08 | 0.009 | 1.48E+01 | 2.84E+05 | 6.01E+02 | 4.25E+06 | 2.51E−08 | 0.009 | 7.45E+00 | 9.46E+04 | 2.00E+02 |
| 2.82E+06 | 5.00E−08 | 0.008 | 1.32E+01 | 2.53E+05 | 5.35E+02 | 4.25E+06 | 2.51E−08 | 0.008 | 6.62E+00 | 8.40E+04 | 1.78E+02 |
| 2.82E+06 | 5.00E−08 | 0.007 | 1.15E+01 | 2.21E+05 | 4.68E+02 | 4.25E+06 | 2.51E−08 | 0.007 | 5.79E+00 | 7.35E+04 | 1.56E+02 |
| 2.82E+06 | 5.00E−08 | 0.006 | 9.90E+00 | 1.89E+05 | 4.01E+02 | 4.25E+06 | 2.51E−08 | 0.006 | 4.97E+00 | 6.30E+04 | 1.33E+02 |
| 2.82E+06 | 5.00E−08 | 0.005 | 8.25E+00 | 1.58E+05 | 3.34E+02 | 4.25E+06 | 2.51E−08 | 0.005 | 4.14E+00 | 5.25E+04 | 1.11E+02 |
| 2.82E+06 | 5.00E−08 | 0.004 | 6.60E+00 | 1.26E+05 | 2.67E+02 | 4.25E+06 | 2.51E−08 | 0.004 | 3.31E+00 | 4.20E+04 | 8.90E+01 |
| 2.82E+06 | 5.00E−08 | 0.003 | 4.95E+00 | 9.47E+04 | 2.00E+02 | 4.25E+06 | 2.51E−08 | 0.003 | 2.48E+00 | 3.15E+04 | 6.67E+01 |
| 2.82E+06 | 5.00E−08 | 0.002 | 3.30E+00 | 6.31E+04 | 1.34E+02 | 4.25E+06 | 2.51E−08 | 0.002 | 1.66E+00 | 2.10E+04 | 4.45E+01 |
| 2.82E+06 | 5.00E−08 | 0.001 | 1.65E+00 | 3.16E+04 | 6.68E+01 | 4.25E+06 | 2.51E−08 | 0.001 | 8.28E−01 | 1.05E+04 | 2.22E+01 |

Title: Method and system for controlling biodegradation and temperature in an aerobic or anaerobic subsurface or partially enclosed waste mass.
Inventors: Harold W. Bentley and Richard W. Bentley

TABLE 5
Flowrate, Time, and Power Required to Maintain Example Landfill at 60° C. as
the Biodegradable Fraction Reduced from 0.5 to 0.005

| | | Biodegradable | | | | |
|---|---|---|---|---|---|---|
| | Biodegradation | Fraction | | | | |
| K₃ | Rate k | f_{b} | E_{bio} | Fᵥ | Fᵥ | Fᵥ |
| (erg/cm³) | (sec⁻¹) | (gm/gm) | (erg/cm³) | (cm³/sec) | (ft³/min) | (m³/sec) |
| 2.82E+06 | 5.00E−08 | 0.500 | 8.25E+02 | 1.58E+07 | 3.34E+04 | 1.56E+01 |
| 2.82E+06 | 5.00E−08 | 0.490 | 8.09E+02 | 1.55E+07 | 3.27E+04 | 1.53E+01 |
| 2.82E+06 | 5.00E−08 | 0.480 | 7.92E+02 | 1.52E+07 | 3.21E+04 | 1.50E+01 |
| 2.82E+06 | 5.00E−08 | 0.470 | 7.76E+02 | 1.48E+07 | 3.14E+04 | 1.47E+01 |
| 2.82E+06 | 5.00E−08 | 0.460 | 7.59E+02 | 1.45E+07 | 3.07E+04 | 1.43E+01 |
| 2.82E+06 | 5.00E−08 | 0.450 | 7.43E+02 | 1.42E+07 | 3.01E+04 | 1.40E+01 |
| 2.82E+06 | 5.00E−08 | 0.440 | 7.26E+02 | 1.39E+07 | 2.94E+04 | 1.37E+01 |
| 2.82E+06 | 5.00E−08 | 0.430 | 7.10E+02 | 1.36E+07 | 2.87E+04 | 1.34E+01 |
| 2.82E+06 | 5.00E−08 | 0.420 | 6.93E+02 | 1.33E+07 | 2.81E+04 | 1.31E+01 |
| 2.82E+06 | 5.00E−08 | 0.410 | 6.77E+02 | 1.29E+07 | 2.74E+04 | 1.28E+01 |
| 2.82E+06 | 5.00E−08 | 0.400 | 6.60E+02 | 1.26E+07 | 2.67E+04 | 1.25E+01 |
| 2.82E+06 | 5.00E−08 | 0.390 | 6.44E+02 | 1.23E+07 | 2.61E+04 | 1.22E+01 |
| 2.82E+06 | 5.00E−08 | 0.380 | 6.27E+02 | 1.20E+07 | 2.54E+04 | 1.18E+01 |
| 2.82E+06 | 5.00E−08 | 0.370 | 6.11E+02 | 1.17E+07 | 2.47E+04 | 1.15E+01 |
| 2.82E+06 | 5.00E−08 | 0.360 | 5.94E+02 | 1.14E+07 | 2.41E+04 | 1.12E+01 |
| 2.82E+06 | 5.00E−08 | 0.350 | 5.78E+02 | 1.10E+07 | 2.34E+04 | 1.09E+01 |
| 2.82E+06 | 5.00E−08 | 0.340 | 5.61E+02 | 1.07E+07 | 2.27E+04 | 1.06E+01 |
| 2.82E+06 | 5.00E−08 | 0.330 | 5.45E+02 | 1.04E+07 | 2.20E+04 | 1.03E+01 |
| 2.82E+06 | 5.00E−08 | 0.320 | 5.28E+02 | 1.01E+07 | 2.14E+04 | 9.98E+00 |
| 2.82E+06 | 5.00E−08 | 0.310 | 5.12E+02 | 9.78E+06 | 2.07E+04 | 9.67E+00 |
| 2.82E+06 | 5.00E−08 | 0.300 | 4.95E+02 | 9.47E+06 | 2.00E+04 | 9.35E+00 |
| 2.82E+06 | 5.00E−08 | 0.290 | 4.79E+02 | 9.15E+06 | 1.94E+04 | 9.04E+00 |
| 2.82E+06 | 5.00E−08 | 0.280 | 4.62E+02 | 8.84E+06 | 1.87E+04 | 8.73E+00 |
| 2.82E+06 | 5.00E−08 | 0.270 | 4.46E+02 | 8.52E+06 | 1.80E+04 | 8.42E+00 |
| 2.82E+06 | 5.00E−08 | 0.260 | 4.29E+02 | 8.21E+06 | 1.74E+04 | 8.11E+00 |
| 2.82E+06 | 5.00E−08 | 0.250 | 4.13E+02 | 7.89E+06 | 1.67E+04 | 7.80E+00 |
| 2.82E+06 | 5.00E−08 | 0.240 | 3.96E+02 | 7.58E+06 | 1.60E+04 | 7.48E+00 |
| 2.82E+06 | 5.00E−08 | 0.230 | 3.80E+02 | 7.26E+06 | 1.54E+04 | 7.17E+00 |
| 2.82E+06 | 5.00E−08 | 0.220 | 3.63E+02 | 6.94E+06 | 1.47E+04 | 6.86E+00 |
| 2.82E+06 | 5.00E−08 | 0.210 | 3.47E+02 | 6.63E+06 | 1.40E+04 | 6.55E+00 |
| 2.82E+06 | 5.00E−08 | 0.200 | 3.30E+02 | 6.31E+06 | 1.34E+04 | 6.24E+00 |
| 2.82E+06 | 5.00E−08 | 0.190 | 3.14E+02 | 6.00E+06 | 1.27E+04 | 5.92E+00 |
| 2.82E+06 | 5.00E−08 | 0.180 | 2.97E+02 | 5.68E+06 | 1.20E+04 | 5.61E+00 |
| 2.82E+06 | 5.00E−08 | 0.170 | 2.81E+02 | 5.37E+06 | 1.14E+04 | 5.30E+00 |
| 2.82E+06 | 5.00E−08 | 0.160 | 2.64E+02 | 5.05E+06 | 1.07E+04 | 4.99E+00 |
| 2.82E+06 | 5.00E−08 | 0.150 | 2.47E+02 | 4.73E+06 | 1.00E+04 | 4.68E+00 |
| 2.82E+06 | 5.00E−08 | 0.140 | 2.31E+02 | 4.42E+06 | 9.35E+03 | 4.37E+00 |
| 2.82E+06 | 5.00E−08 | 0.130 | 2.14E+02 | 4.10E+06 | 8.69E+03 | 4.05E+00 |
| 2.82E+06 | 5.00E−08 | 0.120 | 1.98E+02 | 3.79E+06 | 8.02E+03 | 3.74E+00 |
| 2.82E+06 | 5.00E−08 | 0.110 | 1.81E+02 | 3.47E+06 | 7.35E+03 | 3.43E+00 |
| 2.82E+06 | 5.00E−08 | 0.100 | 1.65E+02 | 3.16E+06 | 6.68E+03 | 3.12E+00 |
| 2.82E+06 | 5.00E−08 | 0.090 | 1.48E+02 | 2.84E+06 | 6.01E+03 | 2.81E+00 |
| 2.82E+06 | 5.00E−08 | 0.080 | 1.32E+02 | 2.53E+06 | 5.35E+03 | 2.49E+00 |
| 2.82E+06 | 5.00E−08 | 0.070 | 1.16E+02 | 2.21E+06 | 4.68E+03 | 2.18E+00 |
| 2.82E+06 | 5.00E−08 | 0.060 | 9.90E+01 | 1.89E+06 | 4.01E+03 | 1.87E+00 |
| 2.82E+06 | 5.00E−08 | 0.050 | 8.25E+01 | 1.58E+06 | 3.34E+03 | 1.56E+00 |
| 2.82E+06 | 5.00E−08 | 0.040 | 6.60E+01 | 1.26E+06 | 2.67E+03 | 1.25E+00 |
| 2.82E+06 | 5.00E−08 | 0.030 | 4.95E+01 | 9.47E+05 | 2.00E+03 | 9.35E−01 |
| 2.82E+06 | 5.00E−08 | 0.020 | 3.30E+01 | 6.31E+05 | 1.34E+03 | 6.24E−01 |
| 2.82E+06 | 5.00E−08 | 0.010 | 1.65E+01 | 3.16E+05 | 6.68E+02 | 3.12E−01 |
| 2.82E+06 | 5.00E−08 | 0.009 | 1.48E+01 | 2.84E+05 | 6.01E+02 | 2.81E−01 |
| 2.82E+06 | 5.00E−08 | 0.008 | 1.32E+01 | 2.53E+05 | 5.35E+02 | 2.49E−01 |
| 2.82E+06 | 5.00E−08 | 0.007 | 1.15E+01 | 2.21E+05 | 4.68E+02 | 2.18E−01 |
| 2.82E+06 | 5.00E−08 | 0.006 | 9.90E+00 | 1.89E+05 | 4.01E+02 | 1.87E−01 |
| 2.82E+06 | 5.00E−08 | 0.005 | 8.25E+00 | 1.58E+05 | 3.34E+02 | 1.56E−01 |

| | | | Power | | |
|---|---|---|---|---|---|
| | | | used to | | |
| | | Time to | reach | Cumulative | Cumulative |
| Pressure P | Power | next f_{b} | next f_{b} | total time t | total power |
| (N-m²) | (kw) | (hr) | (kw-hr) | (hr) | (kw-hr) |
| 4.72E+05 | 7.37E+03 | 1.12E+02 | 8.27E+05 | 1.12E+02 | 8.27E+05 |
| 4.63E+05 | 7.07E+03 | 1.15E+02 | 8.10E+05 | 2.27E+02 | 1.64E+06 |
| 4.54E+05 | 6.79E+03 | 1.17E+02 | 7.94E+05 | 3.44E+02 | 2.43E+06 |
| 4.44E+05 | 6.51E+03 | 1.19E+02 | 7.78E+05 | 4.63E+02 | 3.21E+06 |
| 4.35E+05 | 6.23E+03 | 1.22E+02 | 7.61E+05 | 5.85E+02 | 3.97E+06 |
| 4.25E+05 | 5.97E+03 | 1.25E+02 | 7.45E+05 | 7.10E+02 | 4.71E+06 |
| 4.16E+05 | 5.70E+03 | 1.28E+02 | 7.29E+05 | 8.38E+02 | 5.44E+06 |
| 4.06E+05 | 5.45E+03 | 1.31E+02 | 7.12E+05 | 9.69E+02 | 6.16E+06 |
| 3.97E+05 | 5.20E+03 | 1.34E+02 | 6.96E+05 | 1.10E+03 | 6.85E+06 |
| 3.87E+05 | 4.95E+03 | 1.37E+02 | 6.79E+05 | 1.24E+03 | 7.53E+06 |
| 3.78E+05 | 4.71E+03 | 1.41E+02 | 6.63E+05 | 1.38E+03 | 8.19E+06 |
| 3.69E+05 | 4.48E+03 | 1.44E+02 | 6.47E+05 | 1.52E+03 | 8.84E+06 |
| 3.59E+05 | 4.25E+03 | 1.48E+02 | 6.30E+05 | 1.67E+03 | 9.47E+06 |
| 3.50E+05 | 4.03E+03 | 1.52E+02 | 6.14E+05 | 1.83E+03 | 1.01E+07 |
| 3.40E+05 | 3.82E+03 | 1.57E+02 | 5.98E+05 | 1.98E+03 | 1.07E+07 |
| 3.31E+05 | 3.61E+03 | 1.61E+02 | 5.81E+05 | 2.14E+03 | 1.13E+07 |
| 3.21E+05 | 3.41E+03 | 1.66E+02 | 5.65E+05 | 2.31E+03 | 1.18E+07 |
| 3.12E+05 | 3.21E+03 | 1.71E+02 | 5.49E+05 | 2.48E+03 | 1.24E+07 |
| 3.02E+05 | 3.02E+03 | 1.76E+02 | 5.32E+05 | 2.66E+03 | 1.29E+07 |
| 2.93E+05 | 2.83E+03 | 1.82E+02 | 5.16E+05 | 2.84E+03 | 1.34E+07 |
| 2.83E+05 | 2.65E+03 | 1.88E+02 | 4.99E+05 | 3.03E+03 | 1.39E+07 |
| 2.74E+05 | 2.48E+03 | 1.95E+02 | 4.83E+05 | 3.22E+03 | 1.44E+07 |
| 2.65E+05 | 2.31E+03 | 2.02E+02 | 4.67E+05 | 3.42E+03 | 1.49E+07 |
| 2.55E+05 | 2.15E+03 | 2.10E+02 | 4.50E+05 | 3.63E+03 | 1.53E+07 |
| 2.46E+05 | 1.99E+03 | 2.18E+02 | 4.34E+05 | 3.85E+03 | 1.58E+07 |
| 2.36E+05 | 1.84E+03 | 2.27E+02 | 4.18E+05 | 4.08E+03 | 1.62E+07 |
| 2.27E+05 | 1.70E+03 | 2.36E+02 | 4.01E+05 | 4.31E+03 | 1.66E+07 |
| 2.17E+05 | 1.56E+03 | 2.47E+02 | 3.85E+05 | 4.56E+03 | 1.70E+07 |
| 2.08E+05 | 1.43E+03 | 2.58E+02 | 3.69E+05 | 4.82E+03 | 1.73E+07 |
| 1.98E+05 | 1.30E+03 | 2.71E+02 | 3.52E+05 | 5.09E+03 | 1.77E+07 |
| 1.89E+05 | 1.18E+03 | 2.85E+02 | 3.36E+05 | 5.38E+03 | 1.80E+07 |
| 1.80E+05 | 1.06E+03 | 3.00E+02 | 3.19E+05 | 5.68E+03 | 1.83E+07 |
| 1.70E+05 | 9.55E+02 | 3.18E+02 | 3.03E+05 | 5.99E+03 | 1.86E+07 |
| 1.61E+05 | 8.51E+02 | 3.37E+02 | 2.87E+05 | 6.33E+03 | 1.89E+07 |
| 1.51E+05 | 7.54E+02 | 3.59E+02 | 2.70E+05 | 6.69E+03 | 1.92E+07 |
| 1.42E+05 | 6.63E+02 | 3.83E+02 | 2.54E+05 | 7.07E+03 | 1.95E+07 |
| 1.32E+05 | 5.77E+02 | 4.12E+02 | 2.38E+05 | 7.48E+03 | 1.97E+07 |
| 1.23E+05 | 4.98E+02 | 4.45E+02 | 2.21E+05 | 7.93E+03 | 1.99E+07 |
| 1.13E+05 | 4.24E+02 | 4.83E+02 | 2.05E+05 | 8.41E+03 | 2.01E+07 |
| 1.04E+05 | 3.57E+02 | 5.30E+02 | 1.89E+05 | 8.94E+03 | 2.03E+07 |
| 9.45E+04 | 2.95E+02 | 5.85E+02 | 1.72E+05 | 9.53E+03 | 2.05E+07 |
| 8.50E+04 | 2.39E+02 | 6.54E+02 | 1.56E+05 | 1.02E+04 | 2.06E+07 |
| 7.56E+04 | 1.89E+02 | 7.42E+02 | 1.40E+05 | 1.09E+04 | 2.08E+07 |
| 6.61E+04 | 1.44E+02 | 8.56E+02 | 1.24E+05 | 1.18E+04 | 2.09E+07 |
| 5.67E+04 | 1.06E+02 | 1.01E+03 | 1.07E+05 | 1.28E+04 | 2.10E+07 |
| 4.72E+04 | 7.37E+01 | 1.24E+03 | 9.13E+04 | 1.40E+04 | 2.11E+07 |
| 3.78E+04 | 4.71E+01 | 1.60E+03 | 7.53E+04 | 1.56E+04 | 2.12E+07 |
| 2.83E+04 | 2.65E+01 | 2.25E+03 | 5.97E+04 | 1.79E+04 | 2.12E+07 |
| 1.89E+04 | 1.18E+01 | 3.85E+03 | 4.54E+04 | 2.17E+04 | 2.13E+07 |
| 9.45E+03 | 2.95E+00 | 5.85E+02 | 1.72E+03 | 2.23E+04 | 2.13E+07 |
| 8.50E+03 | 2.39E+00 | 6.54E+02 | 1.56E+03 | 2.30E+04 | 2.13E+07 |
| 7.56E+03 | 1.89E+00 | 7.42E+02 | 1.40E+03 | 2.37E+04 | 2.13E+07 |
| 6.61E+03 | 1.44E+00 | 8.56E+02 | 1.24E+03 | 2.46E+04 | 2.13E+07 |
| 5.67E+03 | 1.06E+00 | 1.01E+03 | 1.07E+03 | 2.56E+04 | 2.13E+07 |
| 4.72E+03 | 7.37E−01 | 1.24E+03 | 9.13E+02 | 2.68E+04 | 2.13E+07 |

Title: Method and system for controlling biodegradation and temperature in an aerobic or anaerobic subsurface or partially enclosed waste mass.
Inventors: Harold W. Bentley and Richard W. Bentley

TABLE 6
Calculation of K₁, K₂, and K₃ (as defined in Sections 0034, 0041, and 0043)

| T_{on-off} Range | Tₘₐₓ | T_{cool} | Tᵢₙ | T_{recycle} | T₁ | T̅ | Lᵥ | C_{nc} | Cᵥ |
|---|---|---|---|---|---|---|---|---|---|
| (° C.) | (° C.) | (° C.) | (° C.) | (° C.) | (° C.) | (° C.) | erg-gm⁻¹ | erg/gm/° C. | erg/gm/° C. |
| 60 on-50 off | 60 | 50 | 25 | 35 | 25 | 55 | 2.26E+10 | 7.20E+06 | 1.30E+07 |
| 70 on-50 off | 70 | 50 | 25 | 35 | 25 | 60 | 2.26E+10 | 7.20E+06 | 1.30E+07 |

| T_{on-off} Range | C₁ | C_{w} | ρ_{nc} | ρ₁ | ρ_{vsat(Tin)} | ρ_{vsat(Tmax)} | ρ_{vsat(Tcool)} | ρ_{vsat(Trecycle)} |
|---|---|---|---|---|---|---|---|---|
| (° C.) | erg/gm/° C. | erg/gm/° C. | gm/cm³ | gm/cm³ | gm/cm³ | gm/cm³ | gm/cm³ | gm/cm³ |
| 60 on-50 off | 4.20E+07 | 1.00E+07 | 1.00E−03 | 1.00E+00 | 2.32E−05 | 1.31E−04 | 8.35E−05 | 3.99E−05 |
| 70 on-50 off | 4.20E+07 | 1.00E+07 | 1.00E−03 | 1.00E+00 | 2.32E−05 | 1.99E−04 | 8.35E−05 | 3.99E−05 |

| T_{on-off} Range | RHᵢₙ | RH_{recycle} | Δρᵥ | Δeᵥ | Δeₗ | Δe_{nc} | Δ̅e̅_{nc1} | Δ̅e̅ₗ₁ | Δ̅e̅ᵥ₁ |
|---|---|---|---|---|---|---|---|---|---|
| (° C.) | Fraction | Fraction | gm/cm³ | erg-cm³ | erg-cm³ | erg-cm³ | erg-cm³ | erg-cm³ | erg-cm³ |
| 60 on-50 off | 0.3 | 1.0 | 1.24E−04 | 9.99E+04 | 3.23E+05 | 2.52E+05 | 2.16E+05 | 2.40E+05 | 7.60E+04 |
| 70 on-50 off | 0.3 | 1.0 | 1.92E−04 | 1.79E+05 | 5.78E+05 | 3.24E+05 | 2.52E+05 | 3.49E+05 | 1.15E+05 |

| T_{on-off} Range | Δ̅ρ̅ᵥ₁ | Δ̅e̅_{nc2} | Δ̅e̅ₗ₂ | Δ̅e̅ᵥ₂ | Δρᵥ₂ | K1 | K2 | K3 |
|---|---|---|---|---|---|---|---|---|
| (° C.) | gm/cm³ | erg-cm³ | erg-cm³ | erg-cm³ | gm/cm³ | erg-cm³ | erg-cm³ | erg-cm³ |
| 60 on-50 off | 1.04E−04 | 1.44E+05 | 1.89E+05 | 6.01E+04 | 8.73E−05 | 2.40E+06 | 1.99E+06 | 2.83E+06 |
| 70 on-50 off | 1.38E−04 | 1.80E+05 | 2.97E+05 | 9.95E+04 | 1.21E−04 | 3.13E+06 | 2.72E+06 | 4.27E+06 |

Title: Method and system for controlling biodegradation and temperature in an aerobic or anaerobic subsurface or partially enclosed waste mass.
Inventors: Harold W. Bentley and Richard W. Bentley

TABLE 7
Properties of Air and Water Vapor with Temperature

| | | | | | | | Density | Viscosity (μ) |
|---|---|---|---|---|---|---|---|---|
| | | Density Water | | | | Total Mass/ | Saturated Air | Saturated Air |
| T | | Vapor at T | Molar Volume | Moles | Moles | Molar Vol | at T | at T |
| (° C.) | K | (g-cm⁻³) | air at T, L | H₂O | Air | (g) | (g-cm⁻³) | (kg-m⁻¹-sec⁻¹) |
| 10 | 283.1 | 9.48E−06 | 23.21 | 1.22E−02 | 9.88E−01 | 28.84 | 1.24E−03 | |
| 15 | 288.1 | 1.29E−05 | 23.62 | 1.70E−02 | 9.83E−01 | 28.78 | 1.22E−03 | |
| 20 | 293.1 | 1.74E−05 | 24.03 | 2.33E−02 | 9.77E−01 | 28.71 | 1.19E−03 | 1.80E−05 |
| 25 | 298.1 | 2.32E−05 | 24.44 | 3.16E−02 | 9.68E−01 | 28.62 | 1.17E−03 | 1.82E−05 |
| 30 | 303.1 | 3.06E−05 | 24.85 | 4.23E−02 | 9.58E−01 | 28.51 | 1.15E−03 | 1.83E−05 |
| 35 | 308.1 | 3.99E−05 | 25.26 | 5.60E−02 | 9.44E−01 | 28.36 | 1.12E−03 | 1.84E−05 |
| 40 | 313.1 | 5.15E−05 | 25.67 | 7.35E−02 | 9.26E−01 | 28.16 | 1.10E−03 | 1.85E−05 |
| 45 | 318.1 | 6.59E−05 | 26.08 | 9.55E−02 | 9.04E−01 | 27.92 | 1.07E−03 | 1.84E−05 |
| 50 | 323.1 | 8.35E−05 | 26.49 | 1.23E−01 | 8.77E−01 | 27.62 | 1.04E−03 | 1.84E−05 |
| 55 | 328.1 | 1.05E−04 | 26.90 | 1.57E−01 | 8.43E−01 | 27.25 | 1.01E−03 | 1.83E−05 |
| 60 | 333.1 | 1.31E−04 | 27.31 | 1.99E−01 | 8.01E−01 | 26.79 | 9.81E−04 | 1.82E−05 |
| 65 | 338.1 | 1.62E−04 | 27.72 | 2.49E−01 | 7.51E−01 | 26.23 | 9.46E−04 | 1.79E−05 |
| 70 | 343.1 | 1.99E−04 | 28.13 | 3.11E−01 | 6.89E−01 | 25.56 | 9.09E−04 | 1.75E−05 |
| 75 | 348.1 | 2.42E−04 | 28.54 | 3.84E−01 | 6.16E−01 | 24.75 | 8.67E−04 | 1.70E−05 |
| 80 | 353.1 | 2.94E−04 | 28.95 | 4.72E−01 | 5.28E−01 | 23.79 | 8.22E−04 | 1.64E−05 |
| 85 | 358.1 | 3.53E−04 | 29.36 | 5.76E−01 | 4.24E−01 | 22.65 | 7.71E−04 | 1.56E−05 |

Title: Method and system for controlling biodegradation and temperature in an aerobic or anaerobic subsurface or partially enclosed waste mass.
Inventors: Harold W. Bentley and Richard W. Bentley

TABLE 8
Flowrate, tₒₙ, t_{off} for f_{b} = 0.5, 0.3, and 0.1
Target f_{b} = 0.005, ρ_{w} = 0.4 gm/cm³, C_{w} = 8.37E+4 erg/gm-° C., Ω = 5.4E+10 cm³

| | | | | | | | |
|---|---|---|---|---|---|---|---|
| f_{b} | Ē_{bio} | K₁ | Fᵥ | Fᵥ | tₒₙ | t_{off} | k_{off} |
| fraction | (erg/cm³) | (erg/cm³) | (cm³/s) | (ft³/min) | (min) | (min) | (sec⁻¹) |

Tₘₐₓ = 60° C., T_{cool} = 50° C., f_{b} = 0.5

| | | | | | | | |
|---|---|---|---|---|---|---|---|
| 0.5 | 619.58 | 2.40E+06 | 5.00E+05 | 1.06E+03 | 5.60E+02 | 3.03E+02 | 3.76E−08 |
| 0.5 | 619.58 | 2.40E+06 | 1.00E+06 | 2.12E+03 | 5.82E+02 | 1.52E+02 | 3.76E−08 |
| 0.5 | 619.58 | 2.40E+06 | 1.50E+06 | 3.18E+03 | 6.05E+02 | 1.01E+02 | 3.76E−08 |
| 0.5 | 619.58 | 2.40E+06 | 2.00E+06 | 4.23E+03 | 6.31E+02 | 7.58E+01 | 3.76E−08 |
| 0.5 | 619.58 | 2.40E+06 | 2.50E+06 | 5.29E+03 | 6.58E+02 | 6.06E+01 | 3.76E−08 |
| 0.5 | 619.58 | 2.40E+06 | 3.00E+06 | 6.35E+03 | 6.88E+02 | 5.05E+01 | 3.76E−08 |
| 0.5 | 619.58 | 2.40E+06 | 3.50E+06 | 7.41E+03 | 7.21E+02 | 4.33E+01 | 3.76E−08 |
| 0.5 | 619.58 | 2.40E+06 | 4.00E+06 | 8.47E+03 | 7.57E+02 | 3.79E+01 | 3.76E−08 |
| 0.5 | 619.58 | 2.40E+06 | 4.50E+06 | 9.53E+03 | 7.97E+02 | 3.37E+01 | 3.76E−08 |
| 0.5 | 619.58 | 2.40E+06 | 5.00E+06 | 1.06E+04 | 8.42E+02 | 3.03E+01 | 3.76E−08 |
| 0.5 | 619.58 | 2.40E+06 | 5.50E+06 | 1.16E+04 | 8.92E+02 | 2.76E+01 | 3.76E−08 |
| 0.5 | 619.58 | 2.40E+06 | 6.00E+06 | 1.27E+04 | 9.48E+02 | 2.53E+01 | 3.76E−08 |
| 0.5 | 619.58 | 2.40E+06 | 6.50E+06 | 1.38E+04 | 1.01E+03 | 2.33E+01 | 3.76E−08 |
| 0.5 | 619.58 | 2.40E+06 | 7.00E+06 | 1.48E+04 | 1.08E+03 | 2.17E+01 | 3.76E−08 |
| 0.5 | 619.58 | 2.40E+06 | 7.50E+06 | 1.59E+04 | 1.17E+03 | 2.02E+01 | 3.76E−08 |
| 0.5 | 619.58 | 2.40E+06 | 8.00E+06 | 1.69E+04 | 1.27E+03 | 1.89E+01 | 3.76E−08 |
| 0.5 | 619.58 | 2.40E+06 | 8.50E+06 | 1.80E+04 | 1.38E+03 | 1.78E+01 | 3.76E−08 |
| 0.5 | 619.58 | 2.40E+06 | 9.00E+06 | 1.91E+04 | 1.52E+03 | 1.68E+01 | 3.76E−08 |
| 0.5 | 619.58 | 2.40E+06 | 9.50E+06 | 2.01E+04 | 1.69E+03 | 1.60E+01 | 3.76E−08 |
| 0.5 | 619.58 | 2.40E+06 | 1.00E+07 | 2.12E+04 | 1.90E+03 | 1.52E+01 | 3.76E−08 |
| 0.5 | 619.58 | 2.40E+06 | 1.05E+07 | 2.22E+04 | 2.18E+03 | 1.44E+01 | 3.76E−08 |
| 0.5 | 619.58 | 2.40E+06 | 1.10E+07 | 2.33E+04 | 2.55E+03 | 1.38E+01 | 3.76E−08 |
| 0.5 | 619.58 | 2.40E+06 | 1.15E+07 | 2.43E+04 | 3.07E+03 | 1.32E+01 | 3.76E−08 |
| 0.5 | 619.58 | 2.40E+06 | 1.20E+07 | 2.54E+04 | 3.85E+03 | 1.26E+01 | 3.76E−08 |
| 0.5 | 619.58 | 2.40E+06 | 1.25E+07 | 2.65E+04 | 5.17E+03 | 1.21E+01 | 3.76E−08 |
| 0.5 | 619.58 | 2.40E+06 | 1.30E+07 | 2.75E+04 | 7.86E+03 | 1.17E+01 | 3.76E−08 |
| 0.5 | 619.58 | 2.40E+06 | 1.35E+07 | 2.86E+04 | 1.64E+04 | 1.12E+01 | 3.76E−08 |
| 0.5 | 619.58 | 2.40E+06 | 1.40E+07 | 2.96E+04 | −1.89E+05 | 1.08E+01 | 3.76E−08 |

Tₘₐₓ = 60° C., T_{cool} = 50° C., f_{b} = 0.3

| | | | | | | | |
|---|---|---|---|---|---|---|---|
| 0.3 | 371.75 | 2.40E+06 | 5.00E+05 | 1.06E+03 | 9.58E+02 | 3.03E+02 | 3.76E−08 |
| 0.3 | 371.75 | 2.40E+06 | 1.00E+06 | 2.12E+03 | 1.02E+03 | 1.52E+02 | 3.76E−08 |
| 0.3 | 371.75 | 2.40E+06 | 1.50E+06 | 3.18E+03 | 1.10E+03 | 1.01E+02 | 3.76E−08 |
| 0.3 | 371.75 | 2.40E+06 | 2.00E+06 | 4.23E+03 | 1.18E+03 | 7.58E+01 | 3.76E−08 |
| 0.3 | 371.75 | 2.40E+06 | 2.50E+06 | 5.29E+03 | 1.28E+03 | 6.06E+01 | 3.76E−08 |
| 0.3 | 371.75 | 2.40E+06 | 3.00E+06 | 6.35E+03 | 1.40E+03 | 5.05E+01 | 3.76E−08 |
| 0.3 | 371.75 | 2.40E+06 | 3.50E+06 | 7.41E+03 | 1.55E+03 | 4.33E+01 | 3.76E−08 |
| 0.3 | 371.75 | 2.40E+06 | 4.00E+06 | 8.47E+03 | 1.72E+03 | 3.79E+01 | 3.76E−08 |
| 0.3 | 371.75 | 2.40E+06 | 4.50E+06 | 9.53E+03 | 1.95E+03 | 3.37E+01 | 3.76E−08 |
| 0.3 | 371.75 | 2.40E+06 | 5.00E+06 | 1.06E+04 | 2.23E+03 | 3.03E+01 | 3.76E−08 |
| 0.3 | 371.75 | 2.40E+06 | 5.50E+06 | 1.16E+04 | 2.62E+03 | 2.76E+01 | 3.76E−08 |
| 0.3 | 371.75 | 2.40E+06 | 6.00E+06 | 1.27E+04 | 3.18E+03 | 2.53E+01 | 3.76E−08 |
| 0.3 | 371.75 | 2.40E+06 | 6.50E+06 | 1.38E+04 | 4.02E+03 | 2.33E+01 | 3.76E−08 |
| 0.3 | 371.75 | 2.40E+06 | 7.00E+06 | 1.48E+04 | 5.48E+03 | 2.17E+01 | 3.76E−08 |
| 0.3 | 371.75 | 2.40E+06 | 7.50E+06 | 1.59E+04 | 8.61E+03 | 2.02E+01 | 3.76E−08 |
| 0.3 | 371.75 | 2.40E+06 | 8.00E+06 | 1.69E+04 | 2.01E+04 | 1.89E+01 | 3.76E−08 |

Tₘₐₓ = 60° C., T_{cool} = 50° C., f_{b} = 0.1

| | | | | | | | |
|---|---|---|---|---|---|---|---|
| 0.1 | 123.92 | 2.40E+06 | 5.00E+05 | 1.06E+03 | 3.29E+03 | 3.03E+02 | 3.76E−08 |
| 0.1 | 123.92 | 2.40E+06 | 1.00E+06 | 2.12E+03 | 4.21E+03 | 1.52E+02 | 3.76E−08 |
| 0.1 | 123.92 | 2.40E+06 | 1.50E+06 | 3.18E+03 | 5.84E+03 | 1.01E+02 | 3.76E−08 |
| 0.1 | 123.92 | 2.40E+06 | 2.00E+06 | 4.23E+03 | 9.53E+03 | 7.58E+01 | 3.76E−08 |
| 0.1 | 123.92 | 2.40E+06 | 2.50E+06 | 5.29E+03 | 2.58E+04 | 6.06E+01 | 3.76E−08 |

Tₘₐₓ = 70° C., T_{cool} = 50° C., f_{b} = 0.5

| | | | | | | | |
|---|---|---|---|---|---|---|---|
| 0.5 | 412.50 | 3.13E+06 | 5.00E+05 | 1.06E+03 | 1.75E+03 | 4.43E+02 | 2.50E−08 |
| 0.5 | 412.50 | 3.13E+06 | 1.00E+06 | 2.12E+03 | 1.89E+03 | 2.21E+02 | 2.50E−08 |
| 0.5 | 412.50 | 3.13E+06 | 1.50E+06 | 3.18E+03 | 2.06E+03 | 1.48E+02 | 2.50E−08 |
| 0.5 | 412.50 | 3.13E+06 | 2.00E+06 | 4.23E+03 | 2.26E+03 | 1.11E+02 | 2.50E−08 |
| 0.5 | 412.50 | 3.13E+06 | 2.50E+06 | 5.29E+03 | 2.50E+03 | 8.85E+01 | 2.50E−08 |
| 0.5 | 412.50 | 3.13E+06 | 3.00E+06 | 6.35E+03 | 2.81E+03 | 7.38E+01 | 2.50E−08 |
| 0.5 | 412.50 | 3.13E+06 | 3.50E+06 | 7.41E+03 | 3.20E+03 | 6.32E+01 | 2.50E−08 |
| 0.5 | 412.50 | 3.13E+06 | 4.00E+06 | 8.47E+03 | 3.71E+03 | 5.53E+01 | 2.50E−08 |
| 0.5 | 412.50 | 3.13E+06 | 4.50E+06 | 9.53E+03 | 4.42E+03 | 4.92E+01 | 2.50E−08 |
| 0.5 | 412.50 | 3.13E+06 | 5.00E+06 | 1.06E+04 | 5.47E+03 | 4.43E+01 | 2.50E−08 |
| 0.5 | 412.50 | 3.13E+06 | 5.50E+06 | 1.16E+04 | 7.16E+03 | 4.02E+01 | 2.50E−08 |
| 0.5 | 412.50 | 3.13E+06 | 6.00E+06 | 1.27E+04 | 1.04E+04 | 3.69E+01 | 2.50E−08 |
| 0.5 | 412.50 | 3.13E+06 | 6.50E+06 | 1.38E+04 | 1.89E+04 | 3.40E+01 | 2.50E−08 |
| 0.5 | 412.50 | 3.13E+06 | 7.00E+06 | 1.48E+04 | 1.04E+05 | 3.16E+01 | 2.50E−08 |

Tₘₐₓ = 70° C., T_{cool} = 50° C., f_{b} = 0.3

| | | | | | | | |
|---|---|---|---|---|---|---|---|
| 0.3 | 247.50 | 3.13E+06 | 5.00E+05 | 1.06E+03 | 3.06E+03 | 4.43E+02 | 2.50E−08 |
| 0.3 | 247.50 | 3.13E+06 | 1.00E+06 | 2.12E+03 | 3.53E+03 | 2.21E+02 | 2.50E−08 |
| 0.3 | 247.50 | 3.13E+06 | 1.10E+06 | 2.33E+03 | 3.65E+03 | 2.01E+02 | 2.50E−08 |
| 0.3 | 247.50 | 3.13E+06 | 1.20E+06 | 2.54E+03 | 3.76E+03 | 1.84E+02 | 2.50E−08 |
| 0.3 | 247.50 | 3.13E+06 | 1.30E+06 | 2.75E+03 | 3.89E+03 | 1.70E+02 | 2.50E−08 |
| 0.3 | 247.50 | 3.13E+06 | 1.40E+06 | 2.96E+03 | 4.03E+03 | 1.58E+02 | 2.50E−08 |
| 0.3 | 247.50 | 3.13E+06 | 1.50E+06 | 3.18E+03 | 4.17E+03 | 1.48E+02 | 2.50E−08 |
| 0.3 | 247.50 | 3.13E+06 | 1.60E+06 | 3.39E+03 | 4.33E+03 | 1.38E+02 | 2.50E−08 |
| 0.3 | 247.50 | 3.13E+06 | 1.70E+06 | 3.60E+03 | 4.50E+03 | 1.30E+02 | 2.50E−08 |
| 0.3 | 247.50 | 3.13E+06 | 1.80E+06 | 3.81E+03 | 4.68E+03 | 1.23E+02 | 2.50E−08 |
| 0.3 | 247.50 | 3.13E+06 | 1.90E+06 | 4.02E+03 | 4.88E+03 | 1.16E+02 | 2.50E−08 |
| 0.3 | 247.50 | 3.13E+06 | 2.00E+06 | 4.23E+03 | 5.09E+03 | 1.11E+02 | 2.50E−08 |
| 0.3 | 247.50 | 3.13E+06 | 2.10E+06 | 4.45E+03 | 5.33E+03 | 1.05E+02 | 2.50E−08 |
| 0.3 | 247.50 | 3.13E+06 | 2.20E+06 | 4.66E+03 | 5.59E+03 | 1.01E+02 | 2.50E−08 |
| 0.3 | 247.50 | 3.13E+06 | 2.30E+06 | 4.87E+03 | 5.87E+03 | 9.62E+01 | 2.50E−08 |
| 0.3 | 247.50 | 3.13E+06 | 2.40E+06 | 5.08E+03 | 6.18E+03 | 9.22E+01 | 2.50E−08 |
| 0.3 | 247.50 | 3.13E+06 | 2.50E+06 | 5.29E+03 | 6.53E+03 | 8.85E+01 | 2.50E−08 |
| 0.3 | 247.50 | 3.13E+08 | 2.60E+06 | 5.50E+03 | 6.93E+03 | 8.51E+01 | 2.50E−08 |
| 0.3 | 247.50 | 3.13E+06 | 2.70E+06 | 5.72E+03 | 7.37E+03 | 8.20E+01 | 2.50E−08 |
| 0.3 | 247.50 | 3.13E+06 | 2.80E+06 | 5.93E+03 | 7.87E+03 | 7.90E+01 | 2.50E−08 |
| 0.3 | 247.50 | 3.13E+06 | 2.90E+06 | 6.14E+03 | 8.45E+03 | 7.63E+01 | 2.50E−08 |
| 0.3 | 247.50 | 3.13E+06 | 3.00E+06 | 6.35E+03 | 9.11E+03 | 7.38E+01 | 2.50E−08 |
| 0.3 | 247.50 | 3.13E+06 | 3.10E+06 | 6.56E+03 | 9.89E+03 | 7.14E+01 | 2.50E−08 |
| 0.3 | 247.50 | 3.13E+08 | 3.20E+06 | 6.77E+03 | 1.08E+04 | 6.91E+01 | 2.50E−08 |
| 0.3 | 247.50 | 3.13E+06 | 3.30E+06 | 6.99E+03 | 1.19E+04 | 6.71E+01 | 2.50E−08 |
| 0.3 | 247.50 | 3.13E+06 | 3.40E+06 | 7.20E+03 | 1.33E+04 | 6.51E+01 | 2.50E−08 |
| 0.3 | 247.50 | 3.13E+06 | 3.50E+06 | 7.41E+03 | 1.51E+04 | 6.32E+01 | 2.50E−08 |
| 0.3 | 247.50 | 3.13E+06 | 3.60E+06 | 7.62E+03 | 1.73E+04 | 6.15E+01 | 2.50E−08 |
| 0.3 | 247.50 | 3.13E+06 | 3.70E+06 | 7.83E+03 | 2.04E+04 | 5.98E+01 | 2.50E−08 |
| 0.3 | 247.50 | 3.13E+08 | 3.80E+06 | 8.04E+03 | 2.47E+04 | 5.82E+01 | 2.50E−08 |
| 0.3 | 247.50 | 3.13E+06 | 3.90E+06 | 8.26E+03 | 3.15E+04 | 5.67E+01 | 2.50E−08 |
| 0.3 | 247.50 | 3.13E+06 | 4.00E+06 | 8.47E+03 | 4.33E+04 | 5.53E+01 | 2.50E−08 |
| 0.3 | 247.50 | 3.13E+06 | 4.10E+06 | 8.68E+03 | 6.92E+04 | 5.40E+01 | 2.50E−08 |
| 0.3 | 247.50 | 3.13E+08 | 4.20E+06 | 8.89E+03 | 1.73E+05 | 5.27E+01 | 2.50E−08 |

Title: Method and system for controlling biodegradation and temperature in an aerobic or anaerobic subsurfaceor partially enclosed waste mass.
Inventors: Harold W. Bentley and Richard W. Bentley

TABLE 9
Power and Time Requirements under the Recirculating Mode to Reduce the Biodegradable
Fraction of the Example Landfill from 0.5 to 0.3 at 50° C. min and 60° C. max

| | | | | E_{bio} | | | | |
|---|---|---|---|---|---|---|---|---|
| K₁ | K₂ | Biorate k | f_{b} | (erg/cm³) | Fᵥ | Fᵥ | tₒₙ | t_{off} |
| (erg/cm³) | (erg/cm³) | (sec⁻¹) | (gm/cm) | Ebar | (ft³/min) | (cm³/sec) | (min) | (min) |
| 2.40E+06 | 1.99E+06 | 3.76E−08 | 0.500 | 6.20E+02 | 1.64E+04 | 7.74E+06 | 2.24E+01 | 1.81E+01 |
| 2.40E+06 | 1.99E+06 | 3.76E−08 | 0.490 | 6.07E+02 | 1.64E+04 | 7.74E+06 | 1.42E+03 | 1.81E+01 |
| 2.40E+06 | 1.99E+06 | 3.76E−08 | 0.480 | 5.95E+02 | 1.64E+04 | 7.74E+06 | 1.49E+03 | 1.81E+01 |
| 2.40E+06 | 1.99E+06 | 3.76E−08 | 0.470 | 5.82E+02 | 1.64E+04 | 7.74E+06 | 1.58E+03 | 1.81E+01 |
| 2.40E+06 | 1.99E+06 | 3.76E−08 | 0.460 | 5.70E+02 | 1.64E+04 | 7.74E+06 | 1.68E+03 | 1.81E+01 |
| 2.40E+06 | 1.99E+06 | 3.76E−08 | 0.450 | 5.58E+02 | 1.64E+04 | 7.74E+06 | 1.79E+03 | 1.81E+01 |
| 2.40E+06 | 1.99E+06 | 3.76E−08 | 0.440 | 5.45E+02 | 1.64E+04 | 7.74E+06 | 1.92E+03 | 1.81E+01 |
| 2.40E+06 | 1.99E+06 | 3.76E−08 | 0.430 | 5.33E+02 | 1.64E+04 | 7.74E+06 | 2.07E+03 | 1.81E+01 |
| 2.40E+06 | 1.99E+06 | 3.76E−08 | 0.420 | 5.20E+02 | 1.64E+04 | 7.74E+06 | 2.24E+03 | 1.81E+01 |
| 2.40E+06 | 1.99E+06 | 3.76E−08 | 0.410 | 5.08E+02 | 1.64E+04 | 7.74E+06 | 2.44E+03 | 1.81E+01 |
| 2.40E+06 | 1.99E+06 | 3.76E−08 | 0.400 | 4.96E+02 | 1.64E+04 | 7.74E+06 | 2.68E+03 | 1.81E+01 |
| 2.40E+06 | 1.99E+06 | 3.76E−08 | 0.390 | 4.83E+02 | 1.64E+04 | 7.74E+06 | 2.98E+03 | 1.81E+01 |
| 2.40E+06 | 1.99E+06 | 3.76E−08 | 0.380 | 4.71E+02 | 1.64E+04 | 7.74E+06 | 3.35E+03 | 1.81E+01 |
| 2.40E+06 | 1.99E+06 | 3.76E−08 | 0.370 | 4.58E+02 | 1.64E+04 | 7.74E+06 | 3.82E+03 | 1.81E+01 |
| 2.40E+06 | 1.99E+06 | 3.76E−08 | 0.360 | 4.46E+02 | 1.64E+04 | 7.74E+06 | 4.45E+03 | 1.81E+01 |
| 2.40E+06 | 1.99E+06 | 3.76E−08 | 0.350 | 4.34E+02 | 1.64E+04 | 7.74E+06 | 5.32E+03 | 1.81E+01 |
| 2.40E+06 | 1.99E+06 | 3.76E−08 | 0.340 | 4.21E+02 | 1.64E+04 | 7.74E+06 | 6.63E+03 | 1.81E+01 |
| 2.40E+06 | 1.99E+06 | 3.76E−08 | 0.330 | 4.09E+02 | 1.64E+04 | 7.74E+06 | 8.78E+03 | 1.81E+01 |
| 2.40E+06 | 1.99E+06 | 3.76E−08 | 0.320 | 3.97E+02 | 1.64E+04 | 7.74E+06 | 1.30E+04 | 1.81E+01 |
| 2.40E+06 | 1.99E+06 | 3.76E−08 | 0.310 | 3.84E+02 | 1.64E+04 | 7.74E+06 | 2.51E+04 | 1.81E+01 |
| 2.40E+06 | 1.99E+06 | 3.76E−08 | 0.300 | 3.72E+02 | 1.64E+04 | 7.74E+06 | 3.51E+05 | 1.81E+01 |

| | | Cumulative | | | Power | |
|---|---|---|---|---|---|---|
| tₒₙ total | t_{off} total | Total Time | Fᵥ | P | Usage | Cumulative |
| (hr) | (hr) | (years) | (m³/sec) | (N-m2) | (kw) | (kw-hr) |
| 149.45 | 120.89 | 0.03 | 7.74 | 2.35E+05 | 1.82E+03 | 4.91E+05 |
| 152.53 | 1.95 | 0.05 | 7.74 | 2.35E+05 | 1.82E+03 | 7.71E+05 |
| 155.74 | 1.89 | 0.07 | 7.74 | 2.35E+05 | 1.82E+03 | 1.06E+06 |
| 159.09 | 1.82 | 0.08 | 7.74 | 2.35E+05 | 1.82E+03 | 1.35E+06 |
| 182.59 | 1.76 | 0.10 | 7.74 | 2.35E+05 | 1.82E+03 | 1.65E+06 |
| 166.24 | 1.68 | 0.12 | 7.74 | 2.35E+05 | 1.82E+03 | 1.95E+06 |
| 170.07 | 1.61 | 0.14 | 7.74 | 2.35E+05 | 1.82E+03 | 2.26E+06 |
| 174.07 | 1.53 | 0.16 | 7.74 | 2.35E+05 | 1.82E+03 | 2.58E+06 |
| 178.26 | 1.45 | 0.18 | 7.74 | 2.35E+05 | 1.82E+03 | 2.91E+06 |
| 182.60 | 1.36 | 0.20 | 7.74 | 2.35E+05 | 1.82E+03 | 3.24E+06 |
| 187.29 | 1.27 | 0.23 | 7.74 | 2.35E+05 | 1.82E+03 | 3.59E+08 |
| 192.15 | 1.17 | 0.25 | 7.74 | 2.35E+05 | 1.82E+03 | 3.94E+06 |
| 197.28 | 1.07 | 0.27 | 7.74 | 2.35E+05 | 1.82E+03 | 4.30E+06 |
| 202.69 | 0.96 | 0.29 | 7.74 | 2.35E+05 | 1.82E+03 | 4.67E+06 |
| 208.40 | 0.85 | 0.32 | 7.74 | 2.35E+05 | 1.82E+03 | 5.05E+06 |
| 214.44 | 0.73 | 0.34 | 7.74 | 2.35E+05 | 1.82E+03 | 5.44E+06 |
| 220.84 | 0.60 | 0.37 | 7.74 | 2.35E+05 | 1.82E+03 | 5.84E+06 |
| 227.63 | 0.47 | 0.39 | 7.74 | 2.35E+05 | 1.82E+03 | 6.25E+06 |
| 234.86 | 0.33 | 0.42 | 7.74 | 2.35E+05 | 1.82E+03 | 6.68E+06 |
| 242.56 | 0.18 | 0.45 | 7.74 | 2.35E+05 | 1.82E+03 | 7.12E+06 |
| 250.79 | 0.01 | 0.48 | 7.74 | 2.35E+05 | 1.82E+03 | 7.58E+06 |

Title: Method and system for controlling biodegradation and temperature in an aerobic or anaerobic subsurface or partially enclosed waste mass.
Inventors: Harold W. Bentley and Richard W. Bentley

1. A method and system comprised of a heat exchanging unit and a device that allows redirection or flow control of gas to control biodegradation rate and temperature within an aerobic or anaerobic landfill or other enclosed or partially enclosed waste mass.

2. A method, as defined in claim 1, wherein the exhaust gas from the waste mass may be vented to the atmosphere or passed through an external processing device after passing through the heat exchanging unit and redirection or flow control device.

3. A method, as defined in claim 1, wherein the exhaust gas from the waste mass may be recirculated through the waste mass after passing through the heat exchanging unit and redirection or flow control device.

4. A method, as defined in claim 1, wherein the exhaust gas from the waste mass may be mixed with a quantity of atmospheric air or other gases before being recirculated through the waste mass and after passing through the heat exchanging unit; and after, during, or prior to passage through the redirection or flow control device.

5. A method, as defined in claim 1, wherein the condensate from the waste mass exhaust gas that forms in passing through the heat exchanging unit is collected in some fashion and introduced into the waste mass.

6. A method, as defined in claim 1, wherein the exhaust gas from the waste mass has its flow controlled by the redirection or flow control device in order to reduce the amount or rate at which the exhaust gas is recirculated through the waste mass.

7. A method, as defined in claim 1, wherein the exhaust gas from the waste mass may be continuously recirculated in the manner discussed in claims 3, 4, and 6 in order to control temperature by limiting, augmenting, or removing the oxygen content in the air entering the waste mass, thus reducing, increasing, or stopping the biodegradation process, and simultaneously providing gas flow to remove heat in order to stabilize, reduce, or raise the temperature within the waste mass.

8. A method, as defined in claim 1, wherein the operating temperature of the invention to achieve a safe waste mass temperature is preferably between approximately 10° C. and 80° C., more preferably between 40° C. and 70° C., and most preferably between 50° C. and 60° C.
